(19) United States
(12) Patent Application Publication
(10) Pub. No.: US 2025/0046859 A1
(43) Pub. Date: Feb. 6, 2025

(54) Composite Particulates for Lithium Batteries and Method of Manufacturing

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/364,996

(22) Filed: Aug. 3, 2023

(51) Int. Cl. H01M 10/056; C01B 25/30; C01B 25/45; C01G 25/00; H01M 4/13; H01M 10/0525

(52) U.S. Cl. CPC H01M 10/056; C01B 25/30; C01B 25/45; C01G 25/006; H01M 4/13; H01M 10/0525; H01M 2004/021; H01M 2300/0094

(57) ABSTRACT

The disclosure provides composite particulates for a lithium battery, at least one of the composite particulates comprises (a) a polymer electrolyte comprising a first polymer and a precursor to a second polymer, comprising from 0% to 50% by weight of a lithium salt dissolved or dispersed in the polymer electrolyte, wherein the second polymer precursor comprises a polymerizable, polymerizing, cross-linkable, and/or cross-linking liquid comprising a monomer, an oligomer, an initiator, and/or a cross-linking agent; (b) a plurality of particles of an anode or cathode active material (5-98%) embedded, dispersed in, encapsulated, or bonded by the polymer electrolyte having a lithium ion conductivity from 10⁻⁸ to 5×10⁻² S/cm; (c) particles of an inorganic material (0-30%); and (d) an electron-conducting additive (0-30%). These composite particulates are building blocks for an anode or cathode. Also disclosed is a solid-state electrolyte separator not containing any electrode active material on ion-conducting additive.

### FIELD

The present disclosure relates generally to the field of lithium-ion or lithium metal batteries and, in particular, to composite particulates for use to build an anode, cathode, and/or solid-state electrolyte separator of a lithium battery.

### BACKGROUND

Rechargeable lithium-ion (Li-ion) and lithium metal batteries (e.g., lithium-lithium metal oxide, lithium-sulfur, lithium-selenium, and Li metal-air batteries) are considered promising power sources for electric vehicle (EV), hybrid electric vehicle (HEV), and portable electronic devices, such as lap-top computers and mobile phones.

A unit cell of a lithium-ion battery is typically composed of an anode current collector, an anode or negative electrode layer (containing an anode active material responsible for storing lithium therein, a conductive additive, and a resin binder), an electrolyte and porous separator, a cathode or positive electrode layer (containing a cathode active material responsible for storing lithium therein, a conductive additive, and a resin binder), and a separate cathode current collector. The electrolyte is in ionic contact with both the anode active material and the cathode active material. A porous separator is not required if the electrolyte is a solid-state electrolyte.

The liquid electrolytes used for current lithium-ion batteries and all lithium metal secondary batteries pose some safety concerns. Most of the organic liquid electrolytes can suffer from thermal runaway or explosion problems.

Solid state electrolytes are commonly believed to be relatively safe in terms of improved resistance to fire and explosion. Solid state electrolytes can be divided into organic (polymeric), inorganic, and organic-inorganic composite electrolytes. However, the conductivity of well-known organic polymer solid state electrolytes, such as poly(ethylene oxide) (PEO), polypropylene oxide (PPO), poly(ethylene glycol) (PEG), and poly(acrylonitrile) (PAN), is typically low (<10⁻⁵ S/cm).

Although the inorganic solid-state electrolyte (e.g., garnet-type and metal sulfide-type) can exhibit a high conductivity (from 0.05×10⁻³ to 10⁻² S/cm), the interfacial impedance or resistance between the inorganic solid-state electrolyte and the electrode (cathode or anode) is high. Further, the traditional inorganic ceramic electrolyte is very brittle and has poor film-forming ability and poor mechanical properties. These materials cannot be cost-effectively manufactured.

Furthermore, the most serious drawback of implementing the inorganic solid electrolyte (ISE) in an electrode (anode or cathode) is the notion that it would normally take a high loading of the ISE particles (typically 30-60% by volume) to meet the two essential conditions: (i) the electrolyte must form a contiguous phase through which lithium ions can travel to reach individual particles of an anode or cathode active material; and (ii) substantially each and every electrode active material particle (e.g., graphite or Si particles in the anode or lithium metal oxide particles in the cathode) must be in physical contact with this contiguous electrolyte phase. This implies that the proportion of the electrode active material responsible for the lithium ion storage capability in an electrode would be reduced to less than 40-70%, leading to a significantly reduced energy density of the resulting battery cell. It is thus essential to minimize the amounts of the electrolyte and other non-active materials, such as conductive filler and binder, in an electrode.

The applicant's research group has previously developed the quasi-solid electrolytes (QSE), which may be considered as a fourth type of solid-state electrolyte. In certain variants of the quasi-solid electrolytes, a small amount of liquid electrolyte may be present to help improving the physical and ionic contact between the electrolyte and the electrode, thus reducing the interfacial resistance. A small proportion of liquid solvent dispersed in a majority of polymer matrix may be referred to as a state of “solvent-in-polymer”. If the liquid solvent forms a continuous phase we have a state of “polymer-in-solvent”. Both are herein referred to as a quasi-solid electrolytes. Examples of QSEs are disclosed in the following: Hui He, et al. “Lithium Secondary Batteries Containing a Non-flammable Quasi-solid Electrolyte,” U.S. patent application Ser. No. 13/986,814 (Jun. 10, 2013); U.S. Pat. No. 9,368,831 (Jun. 14, 2016); U.S. Pat. No. 9,601,803 (Mar. 21, 2017); U.S. Pat. No. 9,601,805 (Mar. 21, 2017); U.S. Pat. No. 9,059,481 (Jun. 16, 2015).

However, the presence of certain liquid electrolytes may cause some problems, such as liquid leakage, gassing, and low resistance to high temperature. Therefore, a novel electrolyte system that obviates all or most of these issues is needed.

Hence, a general object of the present invention is to provide a safe, flame/fire-resistant, quasi-solid or solid-state electrolyte system for a rechargeable lithium cell that is compatible with existing battery production facilities or plastic/composite process and equipment. It is a further object of the present invention to provide a strategy for more effectively using a solid electrolyte that occupies a minimal proportion of the total volume of an electrode, yet still forms a contiguous phase in the electrode and is in physical contact with substantially all the electrode active material particles.

### SUMMARY

The present disclosure provides multi-functional composite particulates for a lithium battery, wherein at least one of the composite particulates has a diameter from 100 nm to 50 μm and comprises (a) a polymer electrolyte comprising a first polymer and a precursor to a second polymer and comprising from 0% to 50% (preferably from 0.1% to 40%) by weight of a lithium salt dissolved or dispersed in the polymer electrolyte, wherein the second polymer precursor comprises a polymerizable, polymerizing, cross-linkable, and/or cross-linking liquid comprising a monomer, an oligomer, an initiator, and/or a cross-linking agent and the first polymer and the second polymer precursor form a mixture having a first polymer-to-second polymer weight ratio from 1/99 to 99/1 (preferably from 5/95 to 95/5); (b) a plurality of primary particles of an anode or cathode active material that are embedded in, dispersed in, encapsulated by, or bonded by the polymer electrolyte, which has a lithium ion conductivity from 10⁻⁸ to 5×10⁻² S/cm and wherein the active material primary particles have a diameter or thickness from 1 nm to 20 μm and occupy a weight fraction from 5% to 98% based on the total weight of the composite particulate; (c) particles of an inorganic material having a diameter or thickness from 2 nm to 20 μm and occupying a weight fraction from 0% to 30% (preferably from 0.1% to 20%) based on the total weight of the composite particulate; and (d) an electron-conducting additive having a weight fraction of 0% to 30% (preferably from 0.1% to 20%) based on the total weight of the composite particulate.

These multi-functional composite particulates serve as a building block for building up an anode (negative electrode) or a cathode (positive electrode) of a lithium battery. The first polymer, in the solid-state, acts to hold all the ingredients in a composite particulate together; these ingredients including the second polymer precursor (initially in a liquid or semi-liquid state), lithium salt, particles of inorganic solid electrolyte, and a conductive additive (e.g., carbon nanotubes, graphene sheets, expanded graphite flakes, and carbon black particles, etc.). These individual composite particulates are then combined and compacted together to form an electrode layer, allowing the second polymer precursor to flow around active material particles and to contact and mesh with a separator layer. The subsequent heat-, UV—, or high energy radiation-induced polymerization and/or cross-linking of the second polymer precursor converts the precursor to a second solid-state polymer, which imparts structural integrity to the electrode (anode or cathode) and helps to form a good electrode/separator interface with minimal interfacial impedance.

During such an electrode making process, substantially no solvent removal is needed, which otherwise would require a long chain of ovens (50-120 meters in length). Further importantly, the essential ingredients of an electrode (such as an active material, lithium salt, solid electrolyte, and electron-conducting additive) are already homogeneously mixed and dispersed in individual composite particulates. When combined and merged together, these composite particulates lead to an electrode having a high proportion of active material and a contiguous or continuous electrolyte phase, which is a combination of two ion-conducting polymers and particles of an inorganic solid-state electrolyte.

The disclosure also provides another kind of multi-functional composite particulates for a lithium battery, wherein at least one of the composite particulates has a diameter from 100 nm to 50 μm and comprises (A) a polymer electrolyte comprising a first polymer and a precursor to a second polymer, comprising from 0% to 50% (preferably from 0.1% to 40%) by weight of a lithium salt dissolved or dispersed in said polymer electrolyte, wherein said second polymer precursor comprises a polymerizable, polymerizing, cross-linkable, and/or cross-linking liquid comprising a monomer, an oligomer, an initiator, and/or a cross-linking agent and the first polymer and the second polymer precursor form a mixture having a first polymer-to-second polymer weight ratio from 1/99 to 99/1 (preferably from 5/95 to 95/5); and (B) particles of an inorganic material having a diameter or thickness from 2 nm to 10 μm and occupying a weight fraction from 1% to 98% (preferably from 30% to 95%) based on the total weight of the composite particulate. No anode or cathode active material and no electron-conducting additive are included in the composite particulate. These particulates are particularly useful for building up a solid-state electrolyte-based separator. They can also be included in the anode or cathode to improve the ion conductivity of the resulting anolyte or catholyte. The present disclosure also provides a powder mass comprising these multi-functional composite particulates.

In the multi-functional composite particulates, the second polymer precursor preferably comprises a polymerizable liquid solvent selected from the group consisting of organic compounds containing unsaturated C═C bonds, cyclic carbonates, cyclic esters, cyclic ethers, and combination thereof.

In certain embodiments, the second polymer precursor comprises a polymerizable liquid solvent selected from acrylate, allyl, and vinyl ether monomers or oligomers, vinyl ethylene carbonate (VEC), vinylene carbonate (VC), acrylate or methyl acrylate (such as methyl methacrylate and butyl acrylate), fluorinated vinyl carbonates, vinyl containing phosphates, phosphonate or phosphonic acid (e.g., diethyl allylphosphonate diethyl vinylphosphonate, dimethyl vinylphosphonate, etc.), vinyl acetate, unsaturated phosphazene, vinyl containing ionic liquid (such as 1-vinyl-3-dodecylimidazolium bis(trifluoromethanesulfonyl)imide), functional vinyl sulfide, sulfoxide, or sulfone, Alkyl(meth)acrylate, N,N-dialkylacrylamide, vinyl alkyl ketone, meth(acrylo)nitrile, ethylene oxide, propylene sulfide, alpha-cyanoacrylate, vinylidene cyanide, ε-caprolactone, and ε-caprolactam, vinyl ether and its derivatives, α-methyl vinyl ether, 1,3-dioxolane (DOL), tetrahydrofuran (THF), trioxymethylene, oxazoline, oxetan-2-one, oxirane and thietane, ethylene carbonate (EC), VC, VEC, propylene carbonate (PC), trimethylene carbonate (TMC), organic compounds with epoxy group, —NH₂ group or SH group, or a combination thereof.

In some preferred embodiments, the second polymer precursor comprises chemical species selected from the group consisting of fluorinated monomers having unsaturation for polymerization, sulfones, sulfides, nitriles, phosphates, phosphites, phosphonates, phosphazenes, sulfates, siloxanes, silanes, 1,3-dioxolane (DOL), tetraethylene glycol dimethylether (TEGDME), poly(ethylene glycol)dimethyl ether (PEGDME), diethylene glycol dibutyl ether (DEGDBE), 2-ethoxyethyl ether (EEE), fluoroethylene carbonate (FEC), vinylene carbonate (VC), allyl ethyl carbonate (AEC), tetrahydrofuran (THF), and combinations thereof.

Desirable polymerizable liquid solvents (preferably having a melting point lower than 100° C., more preferably lower than 50° C.) include fluorinated monomers having unsaturation (double bonds or triple bonds that can be opened up for polymerization); e.g., fluorinated vinyl carbonates, fluorinated vinyl monomers, fluorinated esters, fluorinated vinyl esters, and fluorinated vinyl ethers). Fluorinated vinyl esters include R_{f}CO₂CH═CH₂ and Propenyl Ketones, R_{f}COCH═CHCH₃, where R_{f} is F or any F-containing functional group (e.g., CF₂— and CF₂CF₃—).

Two examples of fluorinated vinyl carbonates are given below:

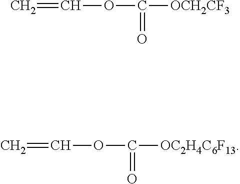

These liquid solvents, as a monomer, can be cured in the presence of an initiator (e.g., 2-Hydroxy-2-methyl-1-phenyl-propan-1-one, Ciba DAROCUR-1173, which can be activated by UV or electron beam):

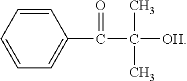

In some embodiments, the fluorinated carbonate is selected from vinyl- or double bond-containing variants of fluoroethylene carbonate (FEC), DFDMEC, FNPEC, a combination thereof, or a combination thereof with hydrofluoro ether (HFE), trifluoro propylene carbonate (FPC), or methyl nonafluorobutyl ether (MFE), wherein the chemical formulae for FEC, DFDMEC, and FNPEC, respectively are shown below:

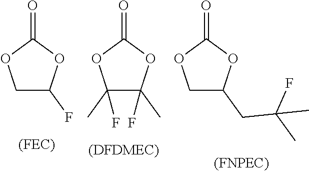

Desirable sulfones as a polymerizable liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone:

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R═NH₂, NO₂ or Br), were reported to be unpolymerizable with free-radical initiators. However, we have observed that phenyl and methyl vinyl sulfones can be polymerized with several anionic-type initiators.

Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

Poly(sulfone)s have high oxygen indices and low smoke emission on burning. Poly(sulfone)s are inherently self-extinguishing materials owing to their highly aromatic character. A hydroxy-terminated copoly(ester sulfone) synthesized by melt polycondensation of the diethylene glycol and 4,4-dihydroxydiethoxydiphenyl sulfone with adipic acid can be used as a flame retardant.

In certain embodiments, the sulfone is selected from TrMS, MTrMS, TMS, or vinyl or double bond-containing variants of TrMS, MTrMS, TMS, EMS, MMES, EMES, EMEES, or a combination thereof; their chemical formulae being given below:

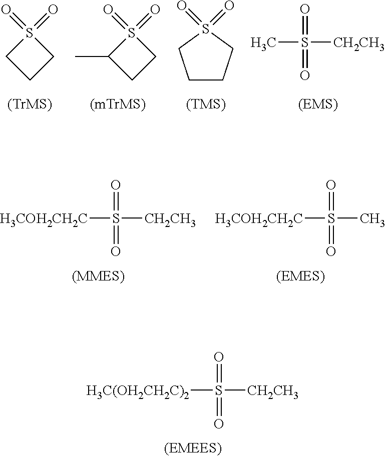

The cyclic structure, such as TrMS, MTrMS, and TMS, can be polymerized via ring-opening polymerization with the assistance of an ionic type initiator.

The nitrile may be selected from dinitriles, such as AND, GLN, SEN, and succinonitrile, which have the following chemical formulae:

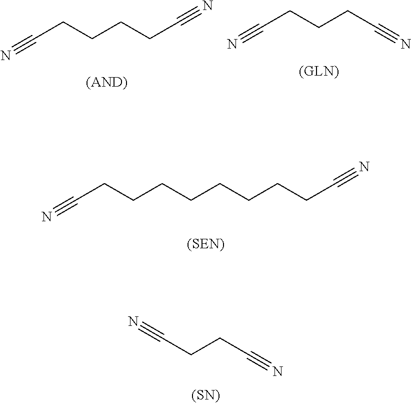

In some embodiments, the phosphate, phosphonate, phosphazene, phosphite, or sulfate is selected from tris(trimethylsilyl)phosphite (TTSPi), alkyl phosphate, triallyl phosphate (TAP), ethylene sulfate (DTD), a combination thereof. The phosphate, alkyl phosphonate, or phosphazene may be selected from the following:

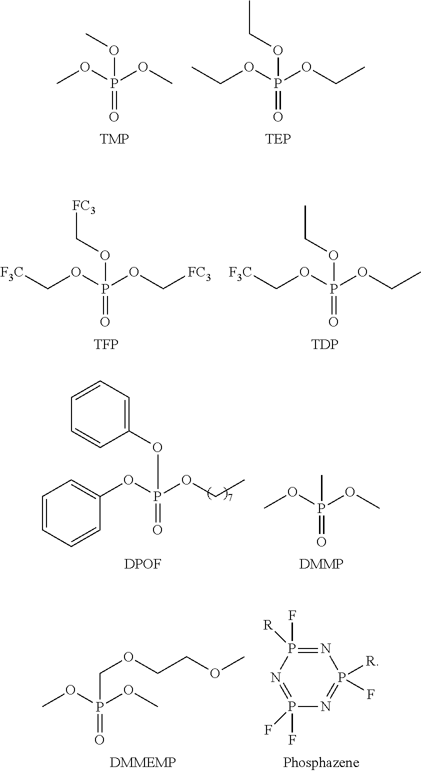

The phosphate, alkyl phosphonate, phosphonic acid, and phosphazene, upon polymerization, are found to be essentially non-flammable. Good examples include diethyl vinylphosphonate, dimethyl vinylphosphonate, vinylphosphonic acid, diethyl allyl phosphate, and diethyl allylphosphonate:

Examples of a polymerizable phosphazene contain derivatives with a general structural formula:

[—NP(A)ₐ(B)_{b}—]ₓ

wherein the groups A and B are bonded to phosphorus atoms through —O—, —S—, —NH—, or —NR— (with R═C₁-C₆)alkyl), and wherein A stands more precisely for a vinyl ether group or a styrene ether group, and B stands more precisely for a hydrocarbon group. In general, A contains at least one vinyl ether group of the general formula Q-O—CR′═CHR″ and/or styrene ether group of the general formula:

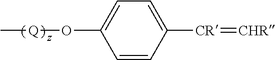

wherein R′ and/or R″ stands for hydrogen or C₁-C₁₀ alkyl; B stands for a reactive or nonreactive hydrocarbon group optionally containing O, S, and/or N, optionally containing at least one reactive group; Q is an aliphatic, cycloaliphatic, aromatic, and/or heterocyclic hydrocarbon group, optionally containing O, S, and/or N; a is a number greater than 0; b is 0 or a number greater than 0 and a+b=2; x stands for a whole number that is at least 2; and z stands for 0 or 1 L Initiators for these phosphazene derivatives can be those of Lewis acids, SbCl₃, AlCl₃, or sulfur compounds.

The siloxane or silane may be selected from alkylsiloxane (Si—O), alkylsilane (Si—C), liquid oligomeric siloxane (—Si—O—Si—), or a combination thereof.

The reactive additive may further comprise an amide group selected from N,N-dimethylacetamide, N,N-diethylacetamide, N,N-dimethylformamide, N,N-diethylformamide, or a combination thereof.

In certain embodiments, the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule.

In certain embodiments, the crosslinking agent is selected from poly(diethanol)diacrylate, poly(ethyleneglycol)dimethacrylate, poly(diethanol)dimethylacrylate, poly(ethylene glycol) diacrylate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

The initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecanoyl peroxide, isobutyryl peroxide, cumene hydroperoxide, tert-butyl peroxypivalate, diisopropyl peroxydicarbonate, or a combination thereof.

In the multi-functional composite particulates, the first polymer may be selected from a thermoplastic, a thermoset or cross-linked polymer, a rubber or elastomer, a semi-interpenetrating network, a simultaneous interpenetrating network, or a combination thereof. There is no restriction on what type of polymers can be used as the first polymer; however, the polymer, with or without the inclusion of a lithium salt, preferably exhibit a lithium-ion conductivity of no less than 10⁻⁸ S/cm, more preferably greater than 10⁻⁶ S/cm, and further more preferably greater than 10⁻⁴ S/cm.

In all the aforementioned embodiments, preferred examples of the first polymer include poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer (e.g., those with a carboxylate anion, a sulfonylimide anion, or sulfonate anion), poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), an acrylic polymer, a copolymer thereof, a semi-penetrating network thereof, a sulfonated derivative thereof, or a combination thereof.

It may be noted that the polymers in the above list are commonly used as an ingredient in a gel polymer electrolyte or solid polymer electrolyte of a lithium-ion battery cell. These polymers, however, have not been previously used in a composite particulate as herein disclosed that serves as a building block for an anode, cathode, or separator.

The lithium salt is preferably selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

The multi-functional composite particulates may initially comprise the first polymer (but not the second polymer precursor) when the composite particulates are made. These composite particles are impregnated with the second polymer precursor before, during, or after being formed into an anode or a cathode, or after a battery cell is made.

The composite particulate may be further encapsulated by a shell of a conducting material selected from a graphene, carbon (e.g. amorphous carbon, CVD carbon, PVD carbon, sputtering carbon, polymeric carbon, carbon nano particles, carbon black, acetylene black, carbon nanotube, carbon nano-fiber, etc.), graphite (e.g. expanded graphene flakes, exfoliated graphite worms, nano-scaled or sub-micron-scaled graphite particles), conducting polymer, metal, composite, or a combination thereof. Preferably, the shell has an electrical conductivity from 10⁻⁸ S/cm to 10³ S/cm, more preferably from 10⁻⁵ S/cm to 10² S/cm and further preferably at least 10⁻² S/cm. The shell preferably has a thickness from 0.34 nm (thickness of a pristine graphene) to 10 μm (preferably less than 1 μm).

In some embodiments, the composite further comprises graphene sheets (inside the particulate as a conductive additive) selected from pristine graphene, graphene oxide, reduced graphene oxide, graphene fluoride, graphene chloride, graphene bromide, graphene iodide, nitrogenated graphene, hydrogenated graphene, doped graphene, chemically functionalized graphene, or a combination thereof.

In some embodiments, the polymer electrolyte further comprises a conductive additive selected from carbon nanotubes, carbon nano-fibers, carbon or graphite fibers, graphene sheets, expanded graphite flakes, metal filaments or metal nano-wires, whiskers, carbon black, acetylene black, needle coke, carbon particles, graphite particles, or a combination thereof. The polymer electrolyte may further comprise a reinforcement material, such as polymer fibrils, glass fibers, ceramic fibers, or a combination. The preferred amount of the conductive additive or reinforcement material is from 1% to 30% by weight based on the total composite particulate weight.

The anode active material may be selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide; (f) prelithiated versions thereof; (g) particles of Li, Li alloy, or surface-stabilized Li having at least 60% by weight of lithium element therein; and (h) combinations thereof. The Li alloy may contain from 0.1% to 10% by weight of a metal element selected from Zn, Ag, Au, Mg, Ni, Ti, Fe, Co, V, Al, or a combination thereof.

The anode active material may contain a prelithiated Si, prelithiated Ge, prelithiated Sn, prelithiated SnOₓ, prelithiated SiOₓ, prelithiated iron oxide, prelithiated Mn₃O₄, prelithiated Co₃O₄, prelithiated Ni₃O₄, lithium titanate, lithium niobite, or a combination thereof, wherein x=1 to 2.

The cathode active material may be selected from an inorganic material, an organic material, a polymeric material, or a combination thereof. The inorganic material, as a cathode active material, may be selected from sulfur, selenium, a metal oxide, metal phosphate, metal silicide, metal selenide, metal sulfide, or a combination thereof.

In some embodiments, the inorganic cathode active material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof. For instance, the inorganic cathode active material may be selected from a lithium transition metal silicate, denoted as Li₂MSiO₄ or Li₂Maₓ Mb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

The metal oxide or metal phosphate, as a cathode active material, may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals. The cathode active material may comprise lithium nickel manganese oxide (LiNiₐ Mn₂₋ₐO₄, 0<a<2), lithium nickel manganese cobalt oxide (LiNiₙ MnₘCo₁₋ₙₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q} Mn_{2-q}O₄, 0<q<2).

The primary particles of anode or cathode active material may be in a form of nano particle, nano wire, nano fiber, nano tube, nano sheet, nano belt, nano ribbon, nano disc, nano platelet, or nano horn having a thickness or diameter from 0.5 nm to 100 nm. In some embodiments, at least one of the primary anode active material particles is coated with a layer of carbon, graphite, or graphene.

In some preferred embodiments, the particles of inorganic material dispersed in the polymer electrolyte matrix comprise particles of an inorganic solid electrolyte material selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof. The particles of inorganic material may be selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

The present disclosure also provides a powder mass comprising the multi-functional composite particulates, wherein the particulates comprise primary particles of an anode active material. Also provided is a powder mass comprising the multi-functional composite particulates, wherein the particulates comprise primary particles of a cathode active material.

The disclosure further provides a battery anode or negative electrode that comprises the disclosed multi-functional composite particulates as an anode material or is made from the multi-functional composite particulates. The disclosure also provides a battery cathode or positive electrode that comprises the multi-functional composite particulates as a cathode material or is made from the multi-functional composite particulates.

The disclosure provides a battery comprising the multi-functional composite particulates as an anode material or a cathode material, wherein the battery is a lithium-ion battery, lithium metal battery, lithium-sulfur battery, lithium-air battery, or lithium-selenium battery.

The present disclosure also provides a method of producing the aforementioned battery, comprising (a) dispensing and consolidating a plurality of the multi-functional composite particulates into a cathode film on at least a surface (preferably two surfaces) of a first solid substrate to form a cathode (positive electrode); (b) providing an anode (negative electrode); (c) providing a separator (e.g., a solid-state electrolyte layer); (d) combining or laminating the cathode, the separator, and the anode into a battery cell and optionally enclosing the cell in a protective housing; and (e) polymerizing and/or cross-linking the second polymer precursor before, during, or after step (d).

In this method, the second polymer precursor may be introduced or added after the composite particulates are produced and before, during or after the cathode is made. Thus, in certain embodiments, the present disclosure provides a method of producing a battery from a plurality of multi-functional composite particulates, the method comprising:
(a) dispensing and consolidating a plurality of the multi-functional composite particulates to form a cathode film on at least a surface of a first solid substrate to form a cathode, wherein at least one of the composite particulates has a diameter from 30 nm to 50 μm and comprises
(i) a polymer electrolyte comprising a first polymer; (ii) a plurality of primary particles of an anode or cathode active material that are embedded in, dispersed in, encapsulated by, or bonded by the polymer electrolyte, which has a lithium ion conductivity from 10⁻⁸ to 5×10⁻² S/cm and wherein the active material primary particles occupy a weight fraction from 5% to 98% based on the total weight of the composite particulate; (iii) particles of an inorganic material having a diameter or thickness from 2 nm to 20 μm and occupying a weight fraction from 0% to 50% (preferably 1% to 30%) based on the total weight of the composite particulate; and (iv) an electron-conducting additive having a weight fraction of 0% to 30% (preferably 1% to 15%) based on the total weight of the composite particulate, and wherein the procedure of dispensing and consolidating comprises mixing the multi-functional composites with a precursor to a second polymer wherein the second polymer precursor comprises a polymerizable, polymerizing, cross-linkable, and/or cross-linking liquid comprising a monomer, an oligomer, an initiator, and/or a cross-linking agent and the first polymer and the second polymer precursor form a mixture having a first polymer-to-second polymer weight ratio from 1/99 to 99/1 and the first polymer and the second polymer precursor combined comprise from 0% to 50% by weight of a lithium salt dissolved or dispersed in the polymer electrolyte;
(b) providing an anode;
(c) providing a separator;
(d) combining or laminating the cathode, the separator, and the anode into a battery cell and optionally enclosing the cell in a protective housing; and
(e) polymerizing and/or cross-linking the second polymer precursor before, during, or after step (d).

In certain embodiments, step (b) comprises dispensing and consolidating a plurality of the multi-functional composite particulates to form an anode film on at least a surface (preferably two surfaces) of a second solid substrate to form an anode.

In some embodiments, step (a) comprises (a-1) electrically charging the plurality of multi-functional composite particulates onto at least a surface of the first solid substrate, initiating polymerization and/or cross-linking, and compressing the composite particulates against the first solid substrate to form a cathode; or comprises (a-2) extruding, initiating polymerization and/or cross-linking, and compressing the composite particulates into a cathode film which is supported on a surface of the first solid substrate.

In some preferred embodiments, step (b) comprises (b-1) electrically charging the plurality of multi-functional composite particulates onto at least a surface of the second solid substrate, initiating polymerization and/or cross-linking, and compressing the composite particulates against the second solid substrate to form an anode; or comprises (b-2) extruding, initiating polymerization and/or cross-linking, and compressing the composite particulates into an anode film which is supported on a surface of the second solid substrate.

In some embodiments, step (c) of providing a separator comprises preparing a separator layer comprising (i) a polymer electrolyte having a lithium ion conductivity from 10⁻⁸ to 5×10⁻² S/cm, comprising a first polymer and a precursor to a second polymer, and comprising from 0% to 50% (preferably from 0.1% to 40%) by weight of a lithium salt dissolved or dispersed in the polymer electrolyte, wherein the second polymer precursor comprises a polymerizable, polymerizing, cross-linkable, and/or cross-linking liquid comprising a monomer, an oligomer, an initiator, and/or a cross-linking agent and the first polymer and the second polymer precursor form a mixture having a first polymer-to-second polymer weight ratio from 1/99 to 99/1 (preferably from 5/95 to 95/5); and (ii) particles of an inorganic material having a diameter or thickness from 2 nm to 10 μm and occupying a weight fraction from 0% to 99% (preferably from 60% to 95%) based on the total weight of the separator layer.

In some preferred embodiments, step (c) of providing a separator comprises a sub-step (c-1) of preparing a plurality of composite particulates wherein at lease a composite particulate comprises (i) a polymer electrolyte having a lithium ion conductivity from 10⁻⁸ to 5×10⁻² S/cm, comprising a first polymer and a precursor to a second polymer, and comprising from 0% to 50% (preferably from 0.1% to 40%) by weight of a lithium salt dissolved or dispersed in the polymer electrolyte, wherein the second polymer precursor comprises a polymerizable, polymerizing, cross-linkable, and/or cross-linking liquid comprising a monomer, an oligomer, an initiator, and/or a cross-linking agent and the first polymer and the second polymer precursor form a mixture having a first polymer-to-second polymer weight ratio from 1/99 to 99/1 (preferably from 5/95 to 95/5); and (ii) particles of an inorganic material having a diameter or thickness from 2 nm to 10 μm and occupying a weight fraction from 0% to 99% (preferably from 30% to 95% and more preferably greater than 60%) based on the total weight of the composite particulate; and a sub-step (c-2) of forming the plurality of composite particulates into a separator layer.

The disclosure further provides a method of producing the aforementioned battery, the method comprising (a) dispensing and consolidating a plurality of the multi-functional composite particulates into an anode film on at least a surface of a first solid substrate to form an anode; (b) providing a cathode; (c) providing a separator; (d) combining or laminating the cathode, the separator, and the anode into a battery cell and optionally enclosing the cell in a protective housing; and (e) polymerizing and/or cross-linking the second polymer precursor before, during, or after step (d).

In all the aforementioned embodiments, the anode, the separator, or both the anode and the separator may preferentially comprise a polymer electrolyte that is substantially the same type of polymer as in the cathode or chemically compatible with the polymer in the cathode.

The disclosure also provides a method of producing the disclosed multi-functional composite particulates, the method comprising (A) dispersing (i) a plurality of primary particles of an anode active material or cathode active material, having a diameter or thickness from 0.5 nm to 20 μm and occupying from 30% to 95% by weight of the composite particles, (ii) from 0.1% to 40% by weight of a lithium salt, and (iii) from 1% to 30% by weight of particles of an inorganic solid electrolyte, having a diameter or thickness from 2 nm to 20 μm, in a liquid mixture to form a reactive slurry, wherein the liquid mixture comprises a polymer electrolyte comprising a first polymer and a precursor to a second polymer, wherein said second polymer precursor comprises a polymerizable, polymerizing, cross-linkable, and/or cross-linking liquid comprising a monomer, an oligomer, an initiator, and/or a cross-linking agent and said first polymer and said second polymer precursor form a mixture having a first polymer-to-second polymer weight ratio from 1/99 to 99/1; (B) forming the reactive slurry into micro-droplets and partially polymerizing and/or curing the monomer or oligomer in the micro-droplets to form the multi-functional particulates.

The intended first polymer may be selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), an acrylic polymer, a copolymer thereof, a semi-penetrating network thereof, a sulfonated derivative thereof, or a combination thereof.

The second polymer precursor preferably comprises a polymerizable liquid solvent selected from the group consisting of organic compounds containing unsaturated C═C bonds, cyclic carbonates, cyclic esters, cyclic ethers, and combination thereof.

In certain embodiments, the second polymer precursor comprises a polymerizable liquid solvent selected from acrylate, allyl, and vinyl ether monomers or oligomers, vinyl ethylene carbonate (VEC), vinylene carbonate (VC), acrylate or methyl acrylate (such as methyl methacrylate and butyl acrylate), fluorinated vinyl carbonates, vinyl containing phosphates, phosphonate or phosphonic acid (e.g., diethyl allylphosphonate diethyl vinylphosphonate, dimethyl vinylphosphonate, etc.), vinyl acetate, unsaturated phosphazene, vinyl containing ionic liquid (such as 1-vinyl-3-dodecylimidazolium bis(trifluoromethanesulfonyl)imide), functional vinyl sulfide, sulfoxide, or sulfone, Alkyl(meth)acrylate, N,N-dialkylacrylamide, vinyl alkyl ketone, meth(acrylo)nitrile, ethylene oxide, propylene sulfide, alpha-cyanoacrylate, vinylidene cyanide, ε-caprolactone, and ε-caprolactam, vinyl ether and its derivatives, α-methyl vinyl ether, 1,3-dioxolane (DOL), tetrahydrofuran (THF), trioxymethylene, oxazoline, oxetan-2-one, oxirane and thietane, ethylene carbonate (EC), VC, VEC, propylene carbonate (PC), trimethylene carbonate (TMC), organic compounds with epoxy group, —NH₂ group or SH group, or a combination thereof.

In some preferred embodiments, the second polymer precursor comprises chemical species selected from the group consisting of fluorinated monomers having unsaturation for polymerization, sulfones, sulfides, nitriles, phosphates, phosphites, phosphonates, phosphazenes, sulfates, siloxanes, silanes, 1,3-dioxolane (DOL), tetraethylene glycol dimethylether (TEGDME), poly(ethylene glycol)dimethyl ether (PEGDME), diethylene glycol dibutyl ether (DEGDBE), 2-ethoxyethyl ether (EEE), fluoroethylene carbonate (FEC), vinylene carbonate (VC), allyl ethyl carbonate (AEC), tetrahydrofuran (THF), and combinations thereof.

In some embodiments, step (B) of forming micro-droplets comprises a procedure selected from pan-coating, air-suspension coating, centrifugal extrusion, vibration-nozzle encapsulation, spray-drying, coacervation-phase separation, interfacial polycondensation or interfacial cross-linking, in-situ polymerization, matrix polymerization, extrusion and palletization, or a combination thereof. In certain preferred embodiments, step (B) comprises conducting spray-drying, fluidized bed coating, or air-suspension coating to produce the multi-functional particulates.

The polymer electrolyte may further comprise a reinforcement material or ion-conducting additive which is preferably selected from carbon nanotubes, carbon nano-fibers, carbon or graphite fibers, graphene sheets, expanded graphite flakes, carbon black, acetylene black, polymeric carbon, polymer fibrils, glass fibers, ceramic fibers, metal filaments, metal nano-wires, or a combination thereof.

In some embodiments, the second polymer precursor contains a monomer, an initiator or catalyst, a crosslinking agent, an oxidizer and/or dopant. During the subsequent electrode and/or separator formation procedure (or after a battery cell is made), one may initiate the polymerization and/or crosslinking reactions to produce linear-chain polymer, branched chain polymer, or a cross-linked network of polymer chains in the electrodes and/or separator. In the particulate, the primary particles of an active material, particles of an inorganic solid electrolyte, an ion-conducting additive, and some optional reinforcement materials, are embedded in or encapsulated by the electrolyte polymer that contains two polymers that are mixed, co-polymerized (to form a copolymer), or cross-linked together to form semi-interpenetrating network (semi-IPN) or simultaneous interpenetrating network (SIN).

The anode active material is preferably in a form of nano particle, nano wire, nano fiber, nano tube, nano sheet, nano belt, nano ribbon, nano disc, nano platelet, or nano horn having a thickness or diameter from 0.5 nm to 100 nm.

In some embodiments, the particles of anode active material contain pre-lithiated particles. In other words, before the electrode active material particles (such as Si or SnO₂) are combined with a sacrificial material and embraced by graphene sheets, these particles have been previously intercalated with Li ions (e.g. via electrochemical charging) up to an amount of 0.1% to 30% by weight of Li. Such a pre-lithiating step may be conducted after the porous anode particulates are made.

In some embodiments, the primary particles of anode or cathode active material contain particles pre-coated with a coating layer of a conductive material selected from carbon, pitch, carbonized resin, a conductive polymer, a conductive organic material, a metal coating, a metal oxide shell, graphene sheets, or a combination thereof. The coating layer thickness is preferably in the range from 1 nm to 20 μm, preferably from 5 nm to 10 μm, and further preferably from 10 nm to 1 μm.

### BRIEF DESCRIPTION OF THE DRAWINGS

FIG. 1 A flow chart showing the process for producing multi-functional composite particulates according to certain embodiments of the present disclosure;

FIG. 2(A) Schematic illustrating multi-functional composite particulate (as a building block for an anode or cathode) according to certain embodiments of the present disclosure;

FIG. 2(B) Schematic illustrating multi-functional composite particulate (as a building block for a solid-state electrolyte/separator) according to certain embodiments of the present disclosure;

FIG. 2(C) SEM image of composite particulates as a building block for an anode;

FIG. 2(D) SEM image of composite particulates as a building block for a cathode;

FIG. 2(E) SEM image of composite particulates as a building block for a solid-state electrolyte separator.

FIG. 3(A) Schematic illustrating a plurality of multi-functional composite particulates can be combined and consolidated (e.g., by heat or by polymer dissolution on surfaces of particulates, followed by solidification) to form an anode or cathode according to certain embodiments of the present disclosure;

FIG. 3(B) Schematic illustrating a plurality of multi-functional composite particulates can be combined and consolidated (e.g., by heat or by polymer dissolution on surfaces of particulates, followed by solidification) to form a solid-state electrolyte-based separator between an anode and a cathode, according to certain embodiments of the present disclosure.

FIG. 4 Schematic of a lithium battery cell comprising an anode layer (preferably made from combining and consolidating multiple composite particulates herein disclosed), an anode current collector, a separator (preferably made from combining and consolidating multiple composite particulates herein disclosed), a cathode layer (preferably made from combining and consolidating multiple composite particulates herein disclosed), and a cathode current collector (e.g., an Al foil), according certain embodiments of the present disclosure.

FIG. 5 Schematic illustrating a process for producing an electrode (anode or cathode) and a multi-layer structure for a battery cell.

### DETAILED DESCRIPTION

A lithium-ion battery cell is typically composed of an anode current collector (e.g., Cu foil), an anode or negative electrode active material layer (i.e., anode layer typically containing particles of an anode active material, conductive additive, and binder), a porous separator with an electrolyte component (or a solid-state electrolyte also serving as a separator layer), a cathode or positive electrode active material layer (containing a cathode active material, conductive additive, and resin binder), and a cathode current collector (e.g. Al foil). More specifically, the anode layer is composed of particles of an anode active material (e.g. graphite, Sn, SnO₂, or Si), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

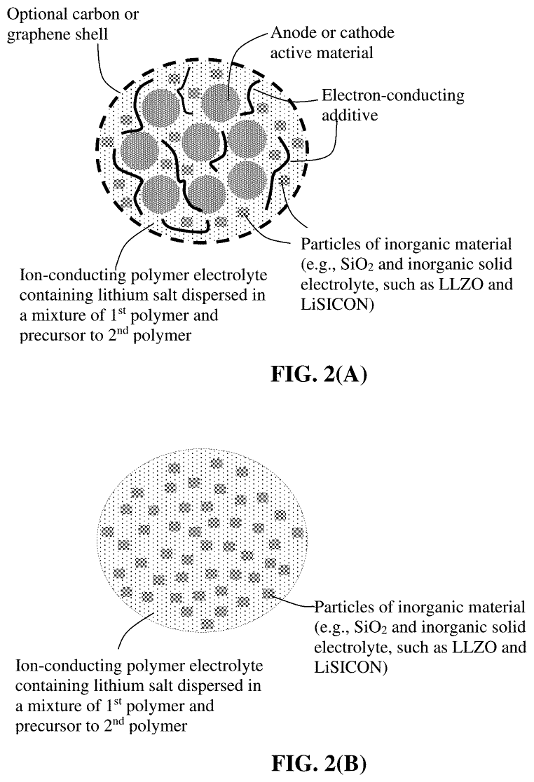

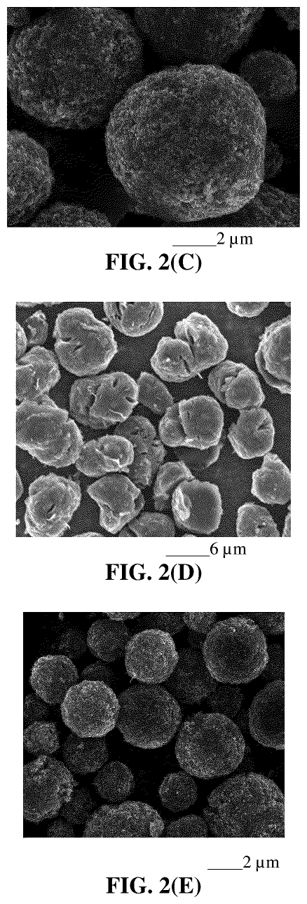

The present disclosure provides multi-functional composite particulates (as schematically illustrated in FIG. 2(A)) for a lithium battery, wherein at least one of the composite particulates has a diameter from 100 nm to 50 μm (preferably from 1 to 20 μm) and comprises (a) a polymer electrolyte comprising a first polymer and a precursor to a second polymer (hereinafter referred to as second polymer precursor) and comprising from 0% to 50% (preferably from 0.1% to 40%) by weight of a lithium salt dissolved or dispersed in the polymer electrolyte, wherein the second polymer precursor comprises a polymerizable, polymerizing, cross-linkable, and/or cross-linking liquid comprising a monomer, an oligomer, an initiator, and/or a cross-linking agent and the first polymer and the second polymer precursor form a mixture having a first polymer-to-second polymer weight ratio from 1/99 to 99/1 (preferably from 5/95 to 95/5); (b) a plurality of primary particles of an anode or cathode active material that are embedded in, dispersed in, encapsulated by, or bonded by the polymer electrolyte, which has a lithium ion conductivity from 10⁻⁸ to 5×10⁻² S/cm and wherein the active material primary particles have a diameter or thickness from 1 nm to 20 μm and occupy a weight fraction from 5% to 98% based on the total weight of the composite particulate; (c) particles of an inorganic material having a diameter or thickness from 2 nm to 20 μm and occupying a weight fraction from 0% to 30% (preferably from 0.1% to 20%) based on the total weight of the composite particulate; and (d) an electron-conducting additive having a weight fraction of 0% to 30% (preferably from 0.1% to 20%) based on the total weight of the composite particulate. Representative scanning electron microscopy (SEM) images for the anode and cathode application are shown in FIG. 2(C) and FIG. 2(D), respectively.

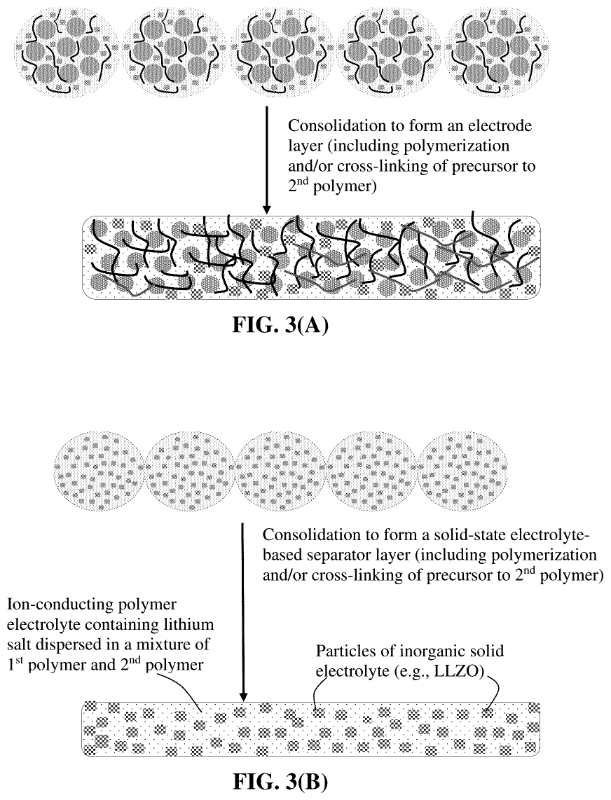

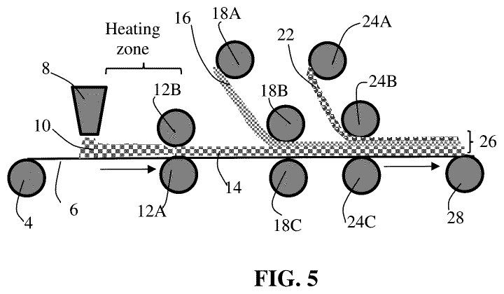

These multi-functional composite particulates serve as a building block for building up an anode (negative electrode) or cathode (positive electrode) through a combination and consolidation procedure, as illustrated in FIG. 3(A). In a preferred embodiment of the instant disclosure, one may simply dispense a powder mass of these multi-functional composite particulates into a primary surface or two primary surfaces of a solid substrate (e.g., an Al foil or Cu foil), followed by heating or UV/energy exposure (to initiate the polymerization and/or cross-linking reaction of the precursor to the second polymer) and roll-pressing. This is schematically illustrated in FIG. 5, which shall be further discussed in a later section. During the consolidation procedure, the composite particulates are deformed and the second polymer precursor, a reactive or reacting fluid, will get squeezed out of the original individual particles and form a substantially continuous or contiguous phase. The demarcation between original particles substantially disappears and all composite particles are merged and integrated together to form an electrode (FIG. 3(A)).

During such an electrode making process, substantially no organic solvent is involved and, hence, no solvent removal procedure is needed, in contrast to the current lithium-ion cell production process which requires a long chain of ovens (typically 50-120 meters in length) to remove solvent and dry out the electrodes.

Further importantly, the essential ingredients of an electrode (such as an active material, lithium salt, solid electrolyte, and electron-conducting additive) are already homogeneously mixed and dispersed in individual composite particulates. When combined and merged together, these composite particulates lead to an electrode having a high proportion of active material and a contiguous or continuous electrolyte phase in which lithium ions can readily transport without interruption.

The notion that these composite particulates have already combined and included all the essential ingredients of an electrode in a desired proportion allows the use of plastic or composite processing processes to manufacture the battery electrode layers at scale. These processes (e.g., compression molding, extrusion, casting, roll-pressing, and lamination) are highly scalable and equipment is readily available, as opposed to the current state-of-the-art solid-state battery processes that require operation of complex and new-type of equipment that must be custom-designed and custom-made (hence, expensive and needing a long time-to-market).

The disclosure also provides another kind of multi-functional composite particulates (schematically illustrated in FIG. 2(B)) for a lithium battery, wherein at least one of the composite particulates has a diameter from 100 nm to 50 μm and comprises (A) a polymer electrolyte, having a lithium ion conductivity from 10⁻⁸ to 5×10⁻² S/cm, comprising a first polymer and a precursor to a second polymer, and comprising from 0% to 50% (preferably from 0.1% to 40%) by weight of a lithium salt dissolved or dispersed in the polymer electrolyte, wherein the second polymer precursor comprises a polymerizable, polymerizing, cross-linkable, and/or cross-linking liquid comprising a monomer, an oligomer, an initiator, and/or a cross-linking agent and the first polymer and the second polymer precursor form a mixture having a first polymer-to-second polymer weight ratio from 1/99 to 99/1 (preferably from 5/95 to 95/5); and (B) particles of an inorganic material having a diameter or thickness from 2 nm to 10 μm and occupying a weight fraction from 1% to 98% (preferably from 30% to 95%) based on the total weight of the composite particulate. No anode or cathode active material and no electron-conducting additive are included in the composite particulate. These particulates are particularly useful for building up a solid-state electrolyte-based separator (e.g., schematically illustrated in FIG. 3(B)). Again, these composite particulates are conducive to fabrication of solid-state electrolyte separator using highly scalable processes, such as compression molding, extrusion, casting, roll-pressing, and lamination. An SEM image for these composite particulates is shown in FIG. 2(E).

Furthermore, these composite particulates can also be included in the anode (as part of an anolyte) or cathode (as part of a catholyte) to improve the ion conductivity of the resulting anolyte or catholyte. The present disclosure also provides a powder mass comprising these multi-functional composite particulates.

In all the aforementioned embodiments, preferred examples of the first polymer in the electrolyte include poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

It may be noted that the polymers in the above list are commonly used as an ingredient in a gel polymer electrolyte or solid polymer electrolyte of a lithium-ion battery cell. These polymers, however, have not been previously used in a composite particulate as herein disclosed that serves as a building block for an anode, cathode, or separator.

For use as a precursor to the second polymer, polymerizable liquid solvents can be classified as organic compounds containing unsaturated C═C bonds, cyclic carbonates, cyclic esters, and cyclic ethers.

The first category mainly includes acrylate, allyl, and vinyl ether monomers or oligomers, while the main differences between different kinds of monomers lie in the chemical and electrochemical properties. Organic compounds containing unsaturated C═C bonds, which can be cured through free radical polymerization, include vinyl ethylene carbonate (VEC), vinylene carbonate (VC), acrylate or methyl acrylate (such as methyl methacrylate and butyl acrylate), fluorinated vinyl carbonates, vinyl containing phosphates, phosphonate or phosphonic acid (e.g., diethyl allylphosphonate diethyl vinylphosphonate, dimethyl vinylphosphonate, etc.), vinyl acetate, unsaturated phosphazene, vinyl containing ionic liquid (such as 1-vinyl-3-dodecylimidazolium bis(trifluoromethanesulfonyl)imide), functional vinyl sulfide, sulfoxide, or sulfone.

Alkyl(meth)acrylate, N,N-dialkylacrylamide, vinyl alkyl ketone, meth(acrylo)nitrile, ethylene oxide, propylene sulfide, alpha-cyanoacrylate, vinylidene cyanide, ε-caprolactone, and ε-caprolactam can be polymerized through anionic polymerization. Vinyl ether and its derivatives, and α-methyl vinyl ether can be polymerized through cationic addition polymerization.

Cyclic esters and cyclic ethers, which can be cured through cationic ring-opening polymerization, include 1,3-dioxolane (DOL), tetrahydrofuran (THF), (trioxymethylene, oxazoline, oxetan-2-one, oxirane and thietane. Cyclic carbonates include ethylene carbonate (EC), VC, VEC, PC (propylene carbonate) and trimethylene carbonate (TMC), which can be polymerized through the ring-opening polymerization. The polymerizable liquid solvents also include some organic compounds with epoxy group and —NH₂ group or SH group.

In the multi-functional composite particulates, the second precursor liquid may be pre-impregnated into the electrolyte polymer during or after the composite particulates are made, but prior to being incorporated in the anode or cathode electrode and the fabrication of the battery cell. However, in certain embodiments, the polymerizable liquid may permeate into the particulates after being injected into an electrode or into the cell after the cell is made.

In certain embodiments, the second polymer precursor comprises a polymerizable liquid solvent selected from acrylate, allyl, and vinyl ether monomers or oligomers, vinyl ethylene carbonate (VEC), vinylene carbonate (VC), acrylate or methyl acrylate (such as methyl methacrylate and butyl acrylate), fluorinated vinyl carbonates, vinyl containing phosphates, phosphonate or phosphonic acid (e.g., diethyl allylphosphonate diethyl vinylphosphonate, dimethyl vinylphosphonate, etc.), vinyl acetate, unsaturated phosphazene, vinyl containing ionic liquid (such as 1-vinyl-3-dodecylimidazolium bis(trifluoromethanesulfonyl)imide), functional vinyl sulfide, sulfoxide, or sulfone, Alkyl(meth)acrylate, N,N-dialkylacrylamide, vinyl alkyl ketone, meth(acrylo)nitrile, ethylene oxide, propylene sulfide, alpha-cyanoacrylate, vinylidene cyanide, ε-caprolactone, and ε-caprolactam, vinyl ether and its derivatives, α-methyl vinyl ether, 1,3-dioxolane (DOL), tetrahydrofuran (THF), trioxymethylene, oxazoline, oxetan-2-one, oxirane and thietane, ethylene carbonate (EC), VC, VEC, propylene carbonate (PC), trimethylene carbonate (TMC), organic compounds with epoxy group, —NH₂ group or SH group, or a combination thereof.

In some preferred embodiments, the second polymer precursor comprises chemical species selected from the group consisting of fluorinated monomers having unsaturation for polymerization, sulfones, sulfides, nitriles, phosphates, phosphites, phosphonates, phosphazenes, sulfates, siloxanes, silanes, 1,3-dioxolane (DOL), tetraethylene glycol dimethylether (TEGDME), poly(ethylene glycol)dimethyl ether (PEGDME), diethylene glycol dibutyl ether (DEGDBE), 2-ethoxyethyl ether (EEE), fluoroethylene carbonate (FEC), vinylene carbonate (VC), allyl ethyl carbonate (AEC), tetrahydrofuran (THF), and combinations thereof.

Desirable polymerizable liquid solvents (preferably having a polymerizable or curing temperature lower than 100° C., more preferably lower than 50° C.) include fluorinated monomers having unsaturation (double bonds or triple bonds) in the backbone or cyclic structure (e.g., fluorinated vinyl carbonates, fluorinated vinyl monomers, fluorinated esters, fluorinated vinyl esters, and fluorinated vinyl ethers). Fluorinated vinyl esters include RfCO₂CH═CH₂ and Propenyl Ketones, R_{f}COCH═CHCH₃, where R_{f} is F or any F-containing functional group (e.g., CF₂— and CF₂CF₃—).

Two examples of fluorinated vinyl carbonates are given below:

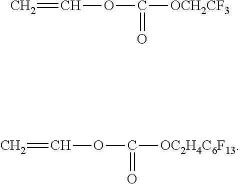

These liquid solvents, as a monomer, can be cured in the presence of an initiator (e.g., 2-Hydroxy-2-methyl-1-phenyl-propan-1-one, Ciba DAROCUR-1173, which can be activated by UV or electron beam):

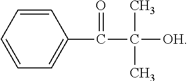

In some embodiments, the fluorinated carbonate is selected from vinyl- or double bond-containing variants of fluoroethylene carbonate (FEC), DFDMEC, FNPEC, a combination thereof, or a combination thereof with hydrofluoro ether (HFE), trifluoro propylene carbonate (FPC), or methyl nonafluorobutyl ether (MFE), wherein the chemical formulae for FEC, DFDMEC, and FNPEC, respectively (all polymerizable via ring-opening polymerization with an ionic initiator) are shown below:

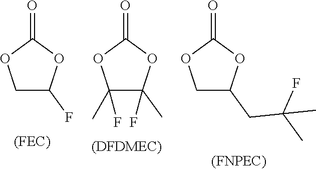

Desirable sulfones as a polymerizable liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone.

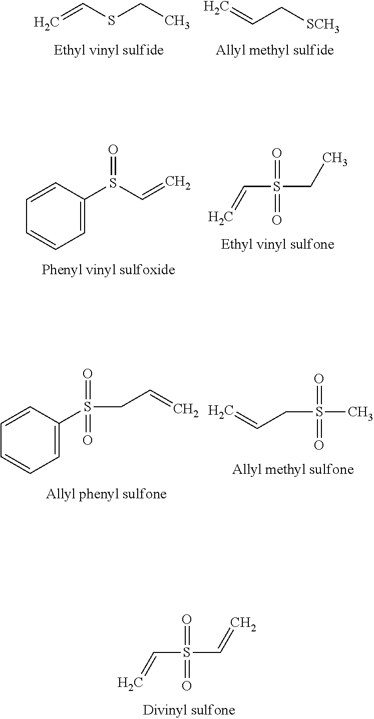

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R═NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

Poly(sulfone)s have high oxygen indices and low smoke emission on burning. Poly(sulfone)s are inherently self-extinguishing materials owing to their highly aromatic character. A hydroxy-terminated copoly(ester sulfone) synthesized by melt polycondensation of the diethylene glycol and 4,4-dihydroxydiethoxydiphenyl sulfone with adipic acid can be used as a flame retardant. Some examples are difunctional β-allyl sulfones and 4,4¢-(m-phenylene-dioxy)bis(benzenesulfonyl chloride):

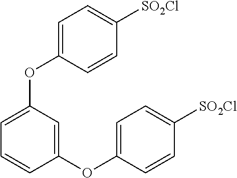 [SMILES: O=S(=O)(Cl)c1ccc(Oc2cccc(Oc3ccc(S(=O)(=O)Cl)cc3)c2)cc1]

Bisphenol S (BPS) and 4,4′-Dichlorodiphenyl sulfone (DCDPS) are additional examples that can be a part of a polymer structure. Bisphenol S (BPS) is an organic compound with the formula (HOC₆H₄)₂SO₂:

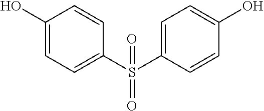 [SMILES: O=S(=O)(c1ccc(O)cc1)c1ccc(O)cc1]

4,4′-Dichlorodiphenyl sulfone (DCDPS), having a MP 148° C., is an organic compound with the formula (ClC₆H₄)₂SO₂:

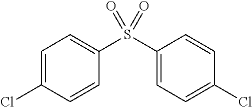 [SMILES: O=S(=O)(c1ccc(Cl)cc1)c1ccc(Cl)cc1]

In certain embodiments, the sulfone is selected from TrMS, MTrMS, TMS, or vinyl or double bond-containing variants of TrMS, MTrMS, TMS, EMS, MMES, EMES, EMEES, or a combination thereof; their chemical formulae being given below:

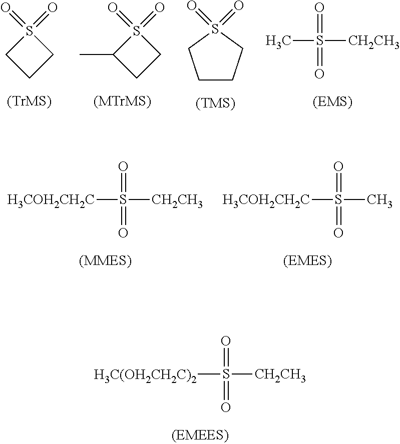

The cyclic structure, such as TrMS, MTrMS, and TMS, can be polymerized via ring-opening polymerization with the assistance of an ionic type initiator.

The nitrile may be selected from AND, GLN, SEN, SN, or a combination thereof and their chemical formulae are given below:

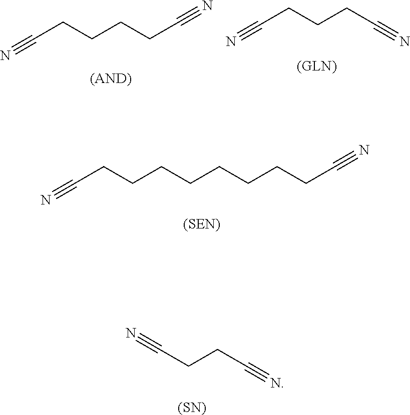

In some embodiments, the phosphate (including various derivatives of phosphoric acid), alkyl phosphonate, phosphazene, phosphite, or sulfate is selected from tris(trimethylsilyl) phosphite (TTSPi), alkyl phosphate, triallyl phosphate (TAP), ethylene sulfate (DTD), a combination thereof, or a combination with 1,3-propane sultone (PS) or propene sultone (PES). The phosphate, alkyl phosphonate, or phosphazene may be selected from the following:

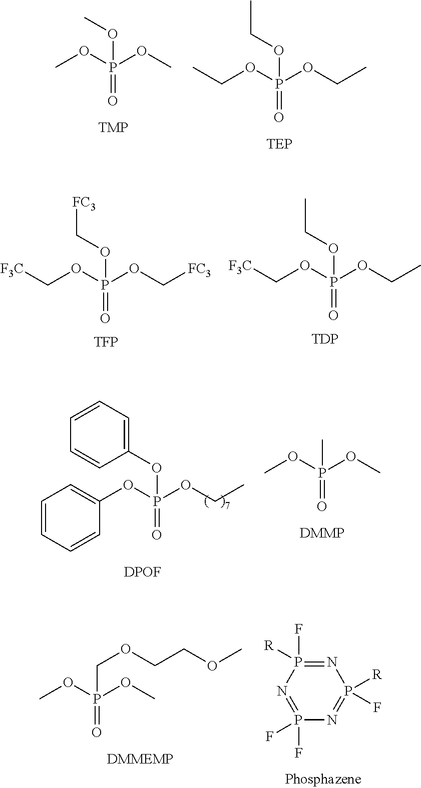

wherein R═H, NH₂, or C₁-C₆ alkyl.

Phosphonate moieties can be readily introduced into vinyl monomers to produce allyl-type, vinyl-type, styrenic-type and (meth)acrylic-type monomers bearing phosphonate groups (e.g., either mono or bisphosphonate). The phosphate, alkyl phosphonate, phosphonic acid, and phosphazene, upon polymerization, are found to be essentially non-flammable. Good examples include diethyl vinylphosphonate, dimethyl vinylphosphonate, vinylphosphonic acid, diethyl allyl phosphate, and diethyl allylphosphonate:

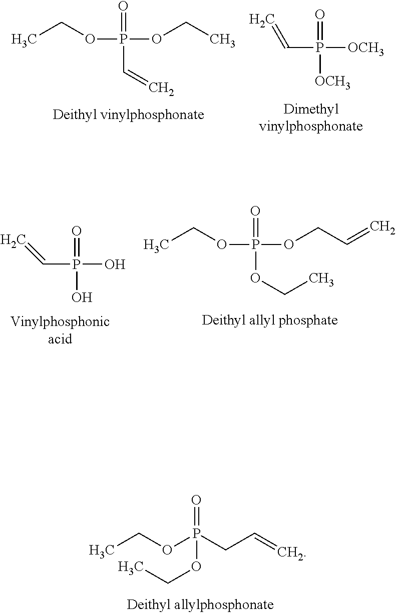

Examples of a polymerizable phosphazene contain derivatives with a general structural formula:

[—NP(A)ₐ(B)_{b}—],

wherein the groups A and B are bonded to phosphorus atoms through —O—, —S—, —NH—, or —NR— (with R═C₁-C₆)alkyl), and wherein A stands more precisely for a vinyl ether group or a styrene ether group, and B stands more precisely for a hydrocarbon group. In general, A contains at least one vinyl ether group of the general formula. Q-O—CR′═CHR″ and/or styrene ether group of the general formula:

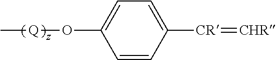

wherein R′ and/or R″ stands for hydrogen or C₁-C₁₀ alkyl; B stands for a reactive or nonreactive hydrocarbon group optionally containing O, S, and/or N, and optionally containing at least one reactive group; Q is an aliphatic, cycloaliphatic, aromatic, and/or heterocyclic hydrocarbon group, optionally containing O, S, and/or N; a is a number greater than 0; b is 0 or a number greater than 0 and a+b=2; x stands for a whole number that is at least 2; and z stands for 0 or 1. Initiators for these phosphazene derivatives can be those of Lewis acids, SbCl₃, AlCl₃, or sulfur compounds.

Examples of initiator compounds that can be used in the polymerization of vinylphosphonic acid are peroxides such as benzoyl peroxide, toluyl peroxide, di-tert.butyl peroxide, chloro benzoyl peroxide, or hydroperoxides such as methylethyl ketone peroxide, tert, butyl hydroperoxide, cumene hydroperoxide, hydrogen Superoxide, or azo-bis-iso-butyro nitrile, or sulfinic acids such as p-methoxyphenyl-sulfinic acid, isoamyl-sulfinic acid, benzene-sulfinic acid, or combinations of various of such catalysts with one another and/or combinations for example, with formaldehyde sodium sulfoxylate or with alkali metal sulfites.

The siloxane or silane may be selected from alkylsiloxane (Si—O), alkylsilane (Si—C), liquid oligomeric siloxane (—Si—O—Si—), or a combination thereof.

The reactive additive may further comprise an amide group selected from N,N-dimethylacetamide, N,N-diethylacetamide, N,N-dimethylformamide, N,N-diethylformamide, or a combination thereof.

In certain embodiments, the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule.

In certain embodiments, the crosslinking agent is selected from poly(diethanol)diacrylate, polyethyleneglycol)dimethacrylate, poly(diethanol)dimethylacrylate, poly(ethylene glycol) diacrylate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

The initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecanoyl peroxide, isobutyryl peroxide, cumene hydroperoxide, tert-butyl peroxypivalate, diisopropyl peroxydicarbonate, or a combination thereof.

The crosslinking agent preferably comprises a compound having at least one reactive group selected from a hydroxyl group, an amino group, an imino group, an amide group, an amine group, an acrylic group, or a mercapto group in the molecule. The amine group is preferably selected from Chemical Formula 2:

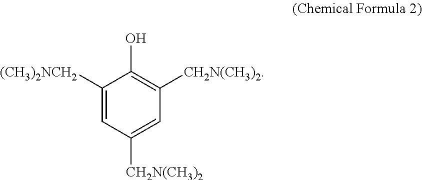

In the rechargeable lithium battery, the reactive additive may further comprise a chemical species represented by Chemical Formula 3 or a derivative thereof and the crosslinking agent comprises a chemical species represented by Chemical Formula 4 or a derivative thereof:

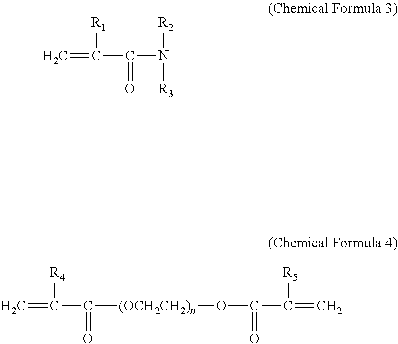

where R₁ is hydrogen or methyl group, and R₂ and R₃ are each independently one selected from the group consisting of hydrogen, methyl, ethyl, propyl, diallylaminopropyl (—C₃H₆N(R′)₂) and hydroxyethyl (CH₂CH₂OH) groups, and R₄ and R₅ are each independently hydrogen or methyl group, and n is an integer from 3 to 30, wherein R′ is C₁-C₅ alkyl group.

Examples of suitable vinyl monomers having Chemical formula 3 include acrylamide, N,N-dimethylacrylamide, N,N-diethylacrylamide, N-isopropylacrylamide, N,N-dimethylamino-propylacrylamide, and N-acryloylmorpholine. Among these species, N-isopropylacrylamide and N-acryloylmorpholine are preferred.

The crosslinking agent is preferably selected from N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid (Formula 4 below), acrylic acid, methacrylic acid, a derivative compound of acrylic acid, a derivative compound of methacrylic acid (e.g. polyhydroxyethylmethacrylate), glycidyl functions, N,N′-Methylenebisacrylamide (MBAAm), Ethylene glycol dimethacrylate (EGDMAAm), isobornyl methacrylate, poly (acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate (e.g. methylene diphenyl diisocyanate, MDI), an urethane chain, a chemical derivative thereof, or a combination thereof.

The lithium salt dispersed or dissolved in the polymer electrolyte is preferably selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, or a combination thereof.

The composite particulate may be further encapsulated by a shell of conducting material selected from a graphene, carbon (e.g. amorphous carbon, CVD carbon, PVD carbon, sputtering carbon, polymeric carbon, carbon nano particles, carbon black, acetylene black, carbon nanotube, carbon nano-fiber, etc.), graphite (e.g. expanded graphene flakes, exfoliated graphite worms, nano-scaled or sub-micron-scaled graphite particles), conducting polymer, metal, composite, or a combination thereof. Preferably, the shell has an electrical conductivity from 10⁻⁸ S/cm to 10³ S/cm, more preferably at least 10⁻² S/cm and further preferably at least 10 S/cm.

In some embodiments, the composite further comprises graphene sheets (dispersed therein as an electron-conducting additive) wherein graphene sheets are selected from pristine graphene, graphene fluoride, graphene chloride, graphene bromide, graphene iodide, nitrogenated graphene, hydrogenated graphene, doped graphene, chemically functionalized graphene, a combination thereof, or a combination thereof with graphene oxide or reduced graphene oxide. Typically, these graphene sheets, along with the primary anode active material particles, are dispersed in the matrix of ionically conducting networks of cross-linked polymer chains. These graphene sheets may be located in the encapsulating shell to embrace the composite droplets and/or be part of the droplets.

In some embodiments, the composite particulates further comprises a conductive additive and/or a reinforcement material selected from carbon nanotubes, carbon nano-fibers, carbon or graphite fibers, graphene sheets, expanded graphite flakes, carbon black, acetylene black, polymer fibrils, glass fibers, ceramic fibers, metal filaments or metal nano-wires, whiskers, carbon black, acetylene black, needle coke, carbon particles, graphite particles, or a combination thereof. The preferred amount of the reinforcement material or additive is from 1% to 30% by weight based on the total composite particulate weight. Electrically conductive reinforcements are preferred.

The anode or cathode active material may be in a form of minute solid or porous particles (primary anode material particles) having a diameter or thickness preferably from 0.5 nm to 2 μm (further preferably from 1 nm to 100 nm). One or a plurality of primary particles are embedded in, encapsulated by, or bonded by an electrolyte polymer to form a micro-droplet. This micro-droplet is may be further encapsulated or embraced by a shell of a conducting material.

Graphite and carbon particles (e.g., soft carbon, hard carbon, and activated carbon) may be used as an anode active material for practicing the instant invention. Preferably, the anode active material is a high-capacity anode active material having a specific lithium storage capacity greater than 372 mAh/g, which is the theoretical capacity of lithium storage in graphite. The primary particles themselves may be porous having porosity in the form of surface pores and/or internal pores. These pores of the primary particles allow the particle to expand into the free space without a significant overall volume increase of the particulate and without inducing any significant volume expansion of the entire anode electrode.

The anode active material may be selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide; (f) prelithiated versions thereof; (g) particles and films of Li, Li alloy, or surface-stabilized Li having at least 60% by weight of lithium element therein; (h) graphite and carbon particles (and fibers or nano-tubes); and (i) combinations thereof. The Li alloy may contain from 0.1% to 10% by weight of a metal element selected from Zn, Ag, Au, Mg, Ni, Ti, Fe, Co, V, Al, or a combination thereof.

The anode active material may contain a prelithiated Si, prelithiated Ge, prelithiated Sn, prelithiated SnOₓ, prelithiated SiOₓ, prelithiated iron oxide, prelithiated Mn₃O₄, prelithiated Co₃O₄, prelithiated Ni₃O₄, lithium titanate, lithium niobite, or a combination thereof, wherein x=1 to 2.

The cathode active material may be selected from an inorganic material, an organic material, a polymeric material, or a combination thereof. The inorganic material, as a cathode active material, may be selected from sulfur, selenium, a metal oxide, metal phosphate, metal silicide, metal selenide, metal sulfide, or a combination thereof.

In some embodiments, the inorganic cathode active material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof. For instance, the inorganic cathode active material may be selected from a lithium transition metal silicate, denoted as Li₂MSiO₄ or Li₂Maₓ Mb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

The metal oxide or metal phosphate, as a cathode active material, may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals. The cathode active material may comprise lithium nickel manganese oxide (LiNiₐ Mn₂₋ₐO₄, 0<a<2), lithium nickel manganese cobalt oxide (LiNiₙ MnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q} Mn_{2-q}O₄, 0<q<2).

The inorganic solid electrolyte material may be selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolyte particles that can be incorporated into the hybrid electrolyte include, but are not limited to, perovskite-type, NASICON-type, garnet-type and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₁₊ₓ MₓTi₂₋ₓ (PO₄)₃ (M=Al, Cr, Ga, Fe, Sc, In, Lu, Y or La). Al substitution has been demonstrated to be the most effective solid-state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a broad series of garnet-type materials may be used as an additive, including Li₅La₃M₂O₁₂ (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B═In or Zr) and the cubic systems Li₇La₃Zr₂O₁₂ and Li_{7.06} M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S, material is dispersed in an elastic polymer as herein disclosed.

Sulfide-type SSEs that have been successfully synthesized include the LPS class, Li₂S—SiS₂ system, Li₆PS₅X (X═Cl, Br, I, and combinations thereof), and Liₓ MP_{y}S_{z} (M=Ge, Sn, Si, Al, and combinations thereof) bases. The lithium thiophosphate or LPS class includes several high-conducting materials. Several sulfide crystalline phases have been found, of which the type of crystal formed depends on the heat treatment applied and the composition of the glass formed. The sulfide crystalline phases include: Li₃PS₄, Li₇P₃S₁₁, Li₇PS₆ and Li₄P₂S₆. The derivatives of Li₆PS₅X include Li_{6-y}PS_{5-y}Cl_{1+y}, Li_{6-y}PS_{5-y}Br_{1+y}, and Li_{6-y}PS_{5-y}I_{1+y} (with y=0-0.5), etc. Examples of Liₓ MP_{y}S_{z} (M=Ge, Sn, Si, Al, and combinations thereof) include Li₁₀GeP₂S₁₂, Li₁₀SnP₂S₁₂, Li₁₀SiP₂S₁₂, and Li₁₁AlP₂S₁₂, Li₁₀Si_{0.3}Sn_{0.7}P₂S₁₂, etc. The particles of all these sulfide-type inorganic electrolytes may be used in the presently disclosed composite particulates.

These inorganic solid electrolyte (ISE) particles embedded in a polymer matrix can help enhance the lithium ion conductivity. Preferably and typically, the polymer electrolyte has a lithium ion conductivity no less than 10⁻⁵ S/cm, more desirably no less than 10⁻⁴ S/cm, further preferably no less than 10⁻³ S/cm, and most preferably no less than 10⁻² S/cm.

It should be noted that certain inorganic solid electrolytes (e.g., sulfide type ISE) can have a higher lithium-ion conductivity as compared to certain selected polymers. However, sulfide type ISEs are air-sensitive and air-sensitive and, hence, cannot be combined with an anode active material (e.g., graphite or Si) to form an anode using water as a liquid medium in a commonly used slurry coating process. Furthermore, sulfide-type ISEs have a very narrow electrochemical stability window (e.g., from 1.8-2.5 V relative to Li/Li⁺), making them unsuitable for use in the anode, where lithium ion intercalation occurs at approximately 0.23 V for graphite and 0.5 V for Si (significantly lower than 1.8 V). They are also unsuitable for the cathode since the cathode active material typically operates at 3.2-4.4 V for lithium iron phosphate and all lithium transition metal oxides. We have solved this problem by embedding the ISE particles in a polymer electrolyte that typically has a significantly wider electrochemical stability window (e.g., can be from 0 to 4.5 V relative to Li/Li⁺). The polymer protection also enables the ISEs processible using the current lithium-ion cell production processes.

The present disclosure also provides a powder mass comprising the multi-functional composite particulates, wherein the particulates comprise primary particles of an anode active material along with other essential ingredients (e.g., lithium salt, particles of solid-state electrolyte, electron-conducting additive, reinforcement, etc.). Also provided is a powder mass comprising the multi-functional composite particulates, wherein the particulates comprise primary particles of a cathode active material along with other essential ingredients.

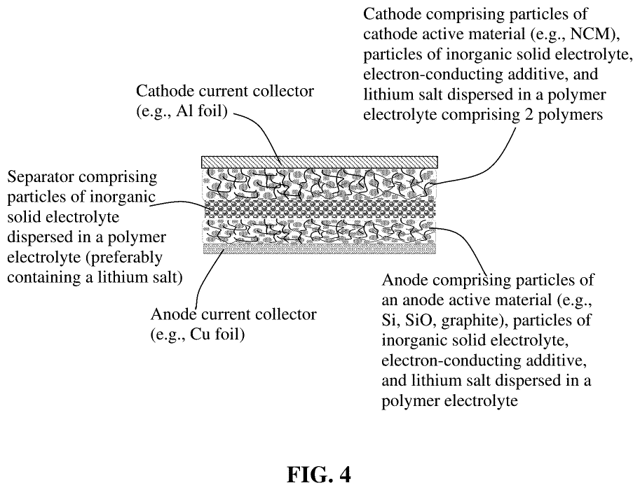

The disclosure further provides a battery anode (or negative electrode) that comprises the disclosed multi-functional composite particulates as an anode material or is made from the multi-functional composite particulates. This is schematically illustrated in FIG. 4 (lower portion). The disclosure also provides a battery cathode (or positive electrode) that comprises the multi-functional composite particulates as a cathode material or is made from the multi-functional composite particulates. This is schematically illustrated in FIG. 4 (upper portion).

The disclosure provides a battery (e.g., schematically illustrated in FIG. 4) comprising the multi-functional composite particulates as an anode material or a cathode material, wherein the battery is a lithium-ion battery, lithium metal battery, lithium-sulfur battery, lithium-air battery, or lithium-selenium battery.

The present disclosure also provides a method of producing the aforementioned battery, comprising (a) dispensing and consolidating a plurality of the multi-functional composite particulates into a cathode film on at least a surface (preferably two surfaces) of a first solid substrate to form a cathode (positive electrode); (b) providing an anode (negative electrode); (c) providing a separator (e.g., a solid-state electrolyte layer); (d) combining or laminating the cathode, the separator, and the anode into a battery cell and optionally enclosing the cell in a protective housing; and (e) polymerizing and/or crosslinking the second polymer precursor. In some preferred embodiments, the process can be conducted in a roll-to-roll manner.

For instance, as schematically illustrated in FIG. 5, the process may begin with unwinding and feeding a solid substrate film 6 (e.g., an Al foil or Cu foil, or a plastic film) from a feeder roller 4; the solid substrate film is driven to move to the right of the figure. A powder dispenser 8 is operated to continuously or intermittently dispense powder 10 of the multi-functional composite particulates onto a surface of the solid substrate film 6. The powder may be pre-heated or heated between the dispenser 8 and a pair of rollers, 12A, 12B to initiate the polymerization or cross-linking of the second polymer precursor (if so desired, at this stage), and roll-pressed by the rollers to form into a solid electrode film 14 (as illustrated in FIG. 3(A)). In certain embodiments of the instant disclosure, this solid electrode film 14 (e.g., a cathode or positive electrode), supported on and bonded to a solid substrate film 6 (e.g., Al foil), may be collected by a collector or winding roller 28 in a roll form. This roll of cathode film may be later unwound from the collector roller and cut and trimmed into pieces of cathode of desired shape and sizes. Rolls of anode electrode and rolls of solid-state electrolyte-based separator may be made from respective composite particulates in a similar manner. A piece of cathode, a separator, and an anode may then be combined into a battery cell.

In certain other embodiments, the solid electrode film 14 (e.g., as a cathode) may continue to move to the right (FIG. 5) and get combined with a separator film 16 delivered via rollers 18A and 18B from a separate solid-state electrolyte or separator production line (not shown). Cathode film 14 and separator film 16 are combined and consolidated by rollers 18B and 18C (as an example) to form a multi-layer structure, which is further combined and consolidated with an anode film 22 via rollers 24A, 24B, and 24C to form a laminate 26. Again, heat may be applied to initiate the polymerization and/or cross-linking of the second polymer precursor during the consolidation procedure. This anode film 22 may be produced in a similar manner as the cathode film on a separate production line (not shown). The laminate 26 may be wound on a collector roller 28 and later unwound, cut and trimmed into desired shape and sizes to make a battery cell.

The initiation of the polymerization and/or cross-linking reactions of the second polymer precursor may begin at any point of time after the composite particulates are made (e.g., during the composite particulate dispensing procedure, electrode fabrication procedure, or cell making procedure, etc.). However, the completion of these reactions preferably occurs after the anode, the separator, and the cathode are combined or laminated together. Such a strategy enables good contact between a separator (and electrolyte) and an electrode (anode or cathode) for minimal interfacial impedance and for continuity of lithium ion pathways.

In certain embodiments, step (b) comprises dispensing and consolidating a plurality of the multi-functional composite particulates into an anode film on at least a surface (preferably two surfaces) of a second solid substrate to form an anode. Again, the anode film is preferably made by a roll-to-roll process as described above.

Several mass production processes may be used to produce an anode, cathode, and separator, not necessarily in the aforementioned roll-to-roll manner. These include, but are not limited to, compression molding, extrusion, casting, roll-pressing, and lamination.

In some embodiments, step (a) comprises (a-1) electrically charging the plurality of multi-functional composite particulates onto at least a surface of the first solid substrate and heating and compressing the composite particulates against the first solid substrate to form a cathode; or comprises (a-2) heating, extruding, and compressing the composite particulates into a cathode film which is supported on a surface of the first solid substrate.

In some preferred embodiments, step (b) comprises (b-1) electrically charging the plurality of multi-functional composite particulates onto at least a surface of the second solid substrate and heating and compressing the composite particulates against the second solid substrate to form an anode; or comprises (b-2) heating, extruding, and compressing the composite particulates into an anode film which is supported on a surface of the second solid substrate.

In some embodiments, step (c) of providing a separator comprises preparing a separator layer comprising (i) a polymer electrolyte comprising from 0.1% to 50% by weight of a lithium salt dissolved or dispersed in said polymer electrolyte comprising a mixture of a first polymer and a precursor to a second polymer, wherein said polymer electrolyte has a lithium ion conductivity from 10⁻⁸ to 5×10⁻² S/cm; and (ii) particles of an inorganic material having a diameter or thickness from 2 nm to 10 μm and occupying a weight fraction from 0% to 99% (preferably from 60% to 95%) based on the total weight of the separator layer.

In some preferred embodiments, step (c) of providing a separator comprises a sub-step (c-1) of preparing a plurality of composite particulates wherein at lease a composite particulate comprises (i) a polymer electrolyte comprising from 0.1% to 50% by weight of a lithium salt dissolved or dispersed in the polymer electrolyte comprising a mixture of a first polymer and a precursor to a second polymer and having a lithium ion conductivity from 10⁻⁸ to 5×10⁻² S/cm; and (ii) particles of an inorganic material having a diameter or thickness from 2 nm to 10 μm and occupying a weight fraction from 0% to 99% (preferably from 60% to 95%) based on the total weight of the composite particulate; and a sub-step (c-2) of forming the plurality of composite particulates into a separator layer.

The disclosure further provides a method of producing the aforementioned battery, the method comprising (a) dispensing and consolidating a plurality of the multi-functional composite particulates into an anode film on at least a surface of a first solid substrate to form an anode; (b) providing a cathode; (c) providing a separator; (d) combining or laminating the cathode, the separator, and the anode into a battery cell and optionally enclosing the cell in a protective housing; and (e) polymerizing and/or cross-linking the second polymer precursor.

The disclosure also provides a method of producing the disclosed multi-functional composite particulates, the method comprising (A) dispersing (i) a plurality of primary particles of an anode active material or cathode active material (having a diameter or thickness from 0.5 nm to 20 μm), (ii) a lithium salt, and (iii) particles of an inorganic solid electrolyte (having a diameter or thickness from 2 nm to 20 μm) in a liquid mixture of a first polymer and a precursor to a second polymer (e.g., containing a monomer or oligomer, an initiator, and/or a cross-linking agent) to form a reactive slurry; (B) forming the reactive slurry into the multi-functional particulates.

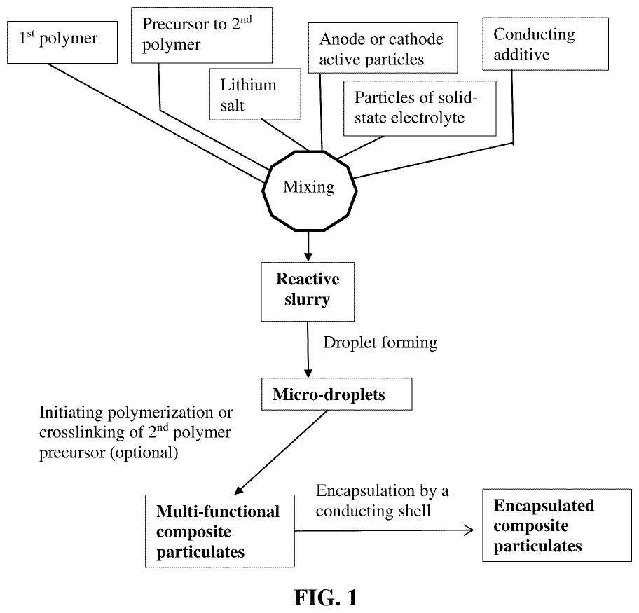

As schematically illustrated in FIG. 1(A), the method comprises mixing the first [polymer and the second polymer precursor (comprising a monomer, initiator, optional curing or crosslinking agent, and optional liquid medium), primary particles of an anode active material, optional reinforcement material, particles of inorganic solid electrolyte and an electron-conducting additive, to form a reactive slurry. One may mix these ingredients sequentially or concurrently. For instance, one may mix all of these ingredients to form the reactive slurry in one pot (one container) all at once and then form the reactive slurry into micro-droplets, allowing the reactants to later react with one another for forming the second polymer that could form a polymer blend, copolymer, or semi-interpenetrating network with the first polymer. The anode or cathode active material particles, along with other ingredients, are dispersed in, embedded in, bonded by, or encapsulated by the electrolyte polymer.

Alternatively, one may first mix certain ingredient(s) in one pot and other ingredients in other pot(s) and then combine them together in one pot. For instance, one may mix the first polymer, the monomer and the initiator (for the second polymer) in one pot, allowing the mixture to proceed to form a reactive oligomer (low molecular weight chains). A separate pot may be used to contain the curing agent (crosslinker). The primary particles of anode active material and other ingredients may be dispersed into either pot or both pots. The ingredients in two pots are then combined together and made into secondary particles using a process such as spraying.

Also provided is a method of producing the multi-functional composite particulates, the method comprising (A) dispersing (i) a plurality of primary particles of an anode active material or cathode active material (having a diameter or thickness from 0.5 nm to 20 μm), (ii) a lithium salt, and (iii) particles of an inorganic solid electrolyte (having a diameter or thickness from 2 nm to 20 μm) in a polymer solution (containing the first polymer dissolved in a liquid solvent, along with the precursor to the second polymer) to form a slurry; (B) forming the slurry into micro-droplets and removing the liquid solvent in the micro-droplets to form the multi-functional particulates. In some embodiments, the reactive slurry further comprises a reinforcement material, an electron-conducting additive, or a combination thereof.

In certain embodiments, the multiple micro-droplets of electrolyte polymer-embedded electrode active material particles are produced by operating a procedure selected from pan-coating, air-suspension coating, centrifugal extrusion, vibration-nozzle encapsulation, spray-drying, coacervation-phase separation, interfacial polycondensation and interfacial cross-linking, in-situ polymerization, matrix polymerization, extrusion and pelletizing, or a combination thereof.

Several micro-encapsulation processes require the polymer to be dissolvable in a solvent or its precursor (or monomer or oligomer) initially contains a liquid state (flowable). Fortunately, all the polymers or their precursors used herein are soluble in some common solvents or the monomer or other polymerizing/curing ingredients are in a liquid state to begin with.

There are three broad categories of micro-encapsulation methods that can be implemented to produce electrolyte polymer-embedded or encapsulated anode particles (the micro-droplets): physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization. In all of these methods, polymerization and/or crosslinking may be allowed to proceed during and/or after the micro-droplet formation procedure.

Pan-coating method: The pan coating process involves tumbling the anode or cathode active material primary particles (along with other ingredients, such as particles of inorganic solid electrolyte, electron-conducting additive, lithium salt, and reinforcement material) in a pan or a similar device while the matrix material (e.g. a polymer+monomer/oligomer liquid or uncured polymer/solvent solution; possibly containing a lithium salt dispersed or dissolved therein) is applied slowly until a desired amount of matrix is attained.

Air-suspension coating method: In the air suspension coating process, the solid primary particles of anode or cathode active material (along with other ingredients) are dispersed into the supporting air stream in an encapsulating chamber. A controlled stream of a reactive precursor solution (e.g. first polymer and second polymer precursor including monomer or oligomer dissolved in a solvent; or its monomer or oligomer alone in a liquid state) is concurrently introduced into this chamber, allowing the solution to hit and coat/embed the suspended particles. These suspended particles are encapsulated by or embedded in the reactive precursor (monomer, oligomer, etc. which is polymerized/cured concurrently or subsequently) while the volatile solvent is removed, leaving behind a composite comprising a matrix of conducting polymer, electrode active material particles, and other ingredients. This process may be repeated several times until the required parameters, such as full-encapsulation, are achieved. The air stream which supports the anode particles also helps to dry them, and the rate of drying is directly proportional to the temperature of the air stream, which can be adjusted for optimized polymer network amount.

In a preferred mode, the particles in the encapsulating zone portion may be subjected to re-circulation for repeated coating. Preferably, the encapsulating chamber is arranged such that the particles pass upwards through the encapsulating zone, then are dispersed into slower moving air and sink back to the base of the encapsulating chamber, enabling repeated passes of the particles through the encapsulating zone until the desired encapsulating matrix amount is achieved.

Centrifugal extrusion: Primary anode particles (along with other ingredients) may be embedded in a polymer or precursor material using a rotating extrusion head containing concentric nozzles. In this process, a stream of core fluid (slurry containing electrode particles and other ingredients dispersed in a solvent) is surrounded by a sheath of shell solution or melt containing the polymer or precursor. As the device rotates and the stream moves through the air it breaks, due to Rayleigh instability, into droplets of core, each coated with the shell solution.

While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle encapsulation method: matrix-encapsulation of anode particles (along with other ingredients) can be conducted using a laminar flow through a nozzle and vibration of the nozzle or the liquid. The vibration has to be done in resonance with the Rayleigh instability, leading to very uniform droplets. The liquid can include any liquids with limited viscosities (1-50,000 mPa·s): emulsions, suspensions or slurry containing the anode active material particles and the polymer or precursor.

Spray-drying: Spray drying may be used to encapsulate electrode particles (along with other ingredients) when the particles are suspended in a melt or polymer/precursor solution to form a suspension. In spray drying, the liquid feed (solution or suspension) is atomized to form droplets which, upon contacts with hot gas, allow solvent to get vaporized and thin polymer shell or matrix to fully embrace the particles.

Coacervation-phase separation: This process includes of three steps carried out under continuous agitation:
(a) Formation of three immiscible chemical phases: liquid manufacturing vehicle phase, core material phase and encapsulation material phase. The particles are dispersed in a solution of the encapsulating polymer or precursor. The encapsulating material phase, which is an immiscible polymer in liquid state, is formed by (i) changing temperature in polymer solution, (ii) addition of salt, (iii) addition of non-solvent, or (iv) addition of an incompatible polymer in the polymer solution.
(b) Deposition of encapsulation material: particles being dispersed in the encapsulating polymer solution, encapsulating polymer/precursor coated around particles, and deposition of liquid polymer embracing around particles by polymer adsorbed at the interface formed between core material and vehicle phase; and
(c) Hardening of encapsulating shell material: shell material being immiscible in vehicle phase and made rigid via thermal, cross-linking, or dissolution techniques.

Interfacial polycondensation and interfacial cross-linking: Interfacial polycondensation entails introducing the two reactants to meet at the interface where they react with each other. This is based on the concept of the Schotten-Baumann reaction between an acid chloride and a compound containing an active hydrogen atom (such as an amine or alcohol), polyester, polyurea, polyurethane, or urea-urethane condensation. Under proper conditions, thin flexible encapsulating shell (wall) forms rapidly at the interface. A suspension of the particles and a diacid chloride are emulsified in water and an aqueous solution containing an amine and a polyfunctional isocyanate is added. A base may be added to neutralize the acid formed during the reaction. Condensed polymer shells form instantaneously at the interface of the emulsion droplets. Interfacial cross-linking is derived from interfacial polycondensation, wherein cross-linking occurs between growing polymer chains and a multi-functional chemical groups to form a polymer shell material.

In-situ polymerization: In some micro-encapsulation processes, particles are fully embedded in a monomer or oligomer first. Then, direct polymerization of the monomer or oligomer is carried out with the presence of these material particles dispersed therein.

Matrix polymerization: This method involves dispersing and embedding electrode primary particles (along with other ingredients) in a polymeric matrix during formation of the particles. This can be accomplished via spray-drying, in which the particles are formed by evaporation of the solvent from the matrix material. Another possible route is the notion that the solidification of the matrix is caused by a chemical change.

The following examples serve to provide the best modes of practice for the present disclosure and should not be construed as limiting the scope of the disclosure:

### Example 1: Preparation of Inorganic Solid Electrolyte (ISE) Powder, Lithium Nitride Phosphate Compound (LIPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form. These ISE particles can be combined with a polymer to form hybrid solid-state electrolyte particulates for use in an anode, a cathode, and/or a separator.

### Example 2: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting inorganic solid electrolyte material was then subjected to grinding in a mortar to form a powder sample to be later added as inorganic solid electrolyte particles encapsulated by an intended polymer electrolyte shell.

### Example 3: Preparation of Garnet-Type Inorganic Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃—9H₂O, La(NO₃)₃—6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was encapsulated in several ion-conducting polymers.

### Example 4: Preparation of Sodium Superionic Conductor (NASICON) Type Inorganic Solid Electrolyte Powder

The Na_{3.1}Zr_{1.95} M_{0.05}Si₂PO₁₂ (M=Mg, Ca, Sr, Ba) materials were synthesized by doping with alkaline earth ions at octahedral 6-coordination Zr sites. The procedure employed includes two sequential steps. Firstly, solid solutions of alkaline earth metal oxides (MO) and ZrO₂ were synthesized by high energy ball milling at 875 rpm for 2 h. Then NASICON Na_{3.1}Zr_{1.95} M_{0.05}Si₂PO₂ structures were synthesized through solid-state reaction of Na₂CO₃, Zr_{1.95} M_{0.05}O_{3.95}, SiO₂, and NH₄H₂PO₄ at 1260° C.

### Example 5: Production of Composite Particulates Comprising Poly(Vinylidene Fluoride)-Hexafluoropropylene (PVDF-HFP) as a First Polymer and DOL as a Precursor to the Second Polymer

PVDF-HFP is dissolvable in a liquid solvent such as 1,3-dioxolane (DOL) and acetone. First, DOL was used to dissolve a lithium salt (LiTFSI) up to a mole ratio of 0.8 at 45° C. and to dissolve PVDF-HFP up to 3% by weight to obtain a first solution, which is a polymer solution. Then, aluminum triflate salts, Al(CF₃SO₃)₃ or Al(OTf)₃, was dissolved in DOL to form a second solution. The two solutions were then mixed together with stirring. Subsequently, 15% by weight (relative to the intended total composite weight) of nano particles of an inorganic solid-state electrolyte (LGPS prepared in Example 2), 2% by weight of carbon nanotubes (CNTs), 1% reduced graphene oxide sheets (from Angstron Materials, Inc.), and 82% by weight of lithium iron phosphate (LFP) particles were dispersed in the polymer solution to obtain a slurry having a solid content of 10% by weight. The slurry was sprayed and cast onto a glass substrate and dried in a vacuum oven at 45° C. overnight to obtain semi-dried powder of composite particulates.

A sample of these composite particulates was placed in a compression-molding mold cavity preset at 45° C. under a light pressure for 2 hours, and cooled down to room temperature to make a cathode supported by an Al foil. Presumably, Al(OTf)₃ initiates polymerization of DOL and transforms a liquid DOL-based electrolyte to a solid polymer (the second polymer). The reaction is initiated by a cationic aluminum species in solution. The aluminum-based cation first attaches to the oxygen atom and initiates the ring-open polymerization. On addition of an amount (>0.5 mM) of Al(OTf)₃, the originally liquid LiTFSI-DOL electrolyte is transformed to a polymer solid.

An anode supported on a Cu foil was prepared in a similar manner, but the LFP particles were replaced by graphene-protected Si anode particles (from Honeycomb Battery Co., Dayton, Ohio). Further, a separator was prepared in a similar manner, but no electrode active material and no electron-conducting additive were included. The cathode, the separator, and the anode were then stacked and heated to 65° C. for 5 hours under a pressure of 14 psi and subsequently cooled to room temperature to prepare a battery cell. The anode, the separator, and the cathode substantially have the same polymer electrolyte that comprise PVDF-HFP and polymerized DOL.

### Example 6: Production of Composite Particulates Comprising Poly(Vinylidene Fluoride)-Hexafluoropropylene (PVDF-HFP) as a First Polymer and Tetrahydrofuran (THF) as a Precursor to the Second Polymer

PVDF-HFP was dissolved in THF to form a first polymer solution. Subsequently, 15% by weight (relative to the intended total composite weight) of nano particles of an inorganic solid-state electrolyte (LGPS prepared in Example 2), 2% by weight of carbon nanotubes (CNTs), 1% reduced graphene oxide sheets (from Angstron Materials, Inc.), and 82% by weight of NCM-811 particles were dispersed in the polymer solution to obtain a slurry having a solid content of approximately 10% by weight.

Separately, 0.6 M LiClO₄ (63.8 mg) was dissolved in liquid THF solvent (1 mL) to form a liquid solution, to which 0.6 M boron trifluoride diethyl ether was added as initiator (85.2 mg) to obtain a reactive solution. This solution was added into the slurry to form a reactive slurry. The slurry was sprayed and cast onto an Al foil surface and dried in a vacuum oven at 45° C. overnight to obtain semi-dried powder of composite particulates. A sample of these composite particulates was placed in a compression-molding mold cavity preset at 45° C. under a light pressure for 2 hours, and cooled down to room temperature to make a cathode supported by an Al foil.

In addition, a separator was prepared in a similar manner, but no electrode active material and no electron-conducting additive were included. A Cu foil, a layer of as-obtained separator, and a layer of the Al foil-supported cathode were then laminated together to form a lithium metal cell initially having no lithium metal on the anode current collector; such a laminate is called “anodeless” lithium metal cell. The cell is left in a mold for 7 days to ensure completion of the THF polymerization reaction.

### Example 7: Production of Composite Particulates Comprising Poly(Acrylonitrile) as a First Polymer and Vinylene Carbonate-Based Precursor for the Second Polymer

Poly(acrylonitrile) (PAN) is soluble in polar solvents, such as dimethylacetamide (DMAc), ethylene carbonate (EC) and propylene carbonate (PC). A lithium sa a LiPF₆) was dissolved in EC for up to a mole ratio of 1.2 at 45° C. Separately, 5% by weight of PAN was dissolved in EC to make a polymer solution. The EC/LiPF₆ solution was then mixed with the EC/PAN solution to form a mixture solution. Nano particles of SiO₂ and LLZO, along with cathode active material particles (NCM-622) and graphene sheets, were then dispersed in the mixture solution to obtain a slurry having a solid content of 4.5%. The amounts of particles and additives were added for the purpose of reaching the following weight %: SiO₂ (8%), LLZO (10%), graphene sheets (2%), and NCM-622 (80%) in the polymer composite. The slurry was spray-dried to form composite particles, which were used as a building block for a cathode.

On a separate basis, 1.43 g LiDFOB was dissolved in 10 mL VC to obtain a homogeneous and transparent solution (1.0 μm LiDFOB in VC, ˜9.6% (w/w)). Subsequently, 10 mg AIBN was added to this solution to form a reactive solution. The composite particles were then immersed in the reactive solution, allowing the reacting species to at least partially permeate into the composite particulates. An amount of the semi-wet composite particulates were compressed to make a layer of cathode on an Al foil surface. A lithium-ion cell was made by stacking this Al-supported cathode, a layer of a cellulose fabric separator (pre-soaked with the VC-based reactive solution), and a graphite-based anode supported on a Cu foil. The lithium-ion cell was maintained at 60° C. for 24 h and 80° C. for 10 h under a light pressure to complete the polymerization of VC.

### Example 8: Preparation of Composite Particulates Comprising an In Situ Polymerizable Fluorinated Vinylene Carbonate (FVC) as a Second Polymer and Poly(Ethyleneglycol)Diacrylate (PEGDA), as a First Polymer

Several types of anode active materials in a fine powder form were investigated. These include Si and SiOₓ (x≈1), which are used as examples to illustrate the best mode of practice. These active materials were either prepared in house or purchased from commercial sources.

In one study, fluorinated vinylene carbonate (FVC) and poly(ethyleneglycol) diacrylate (PEGDA) were stirred under the protection of argon gas until a homogeneous solution was obtained. Subsequently, lithium hexafluoro phosphate was added and dissolved in the above solution to obtain a reactive mixture solution, wherein the weight fractions of fluorinated vinylene carbonate, polyethyleneglycol diacrylate, and lithium hexafluoro phosphate were 85 wt %, 10 wt %, and 5 wt %, respectively. A powder mass of anode active material particles (85%), acetylene black particles (8%), and nano particles of LIPON-type solid-state electrolyte (5%) prepared in Example 1, were combined with the reactive solution to form micro-droplets (composite particulates) via pan-coating. A sample of these micro-droplets was extruded out from a table-top extruder to form a layer of anode.

Separately, a cathode was similarly prepared by replacing the anode active material with a cathode active material, NCM-811 particles.

A separator layer was prepared in a similar manner except for the notion that there were no acetylene black and no anode particles and that the nano particles of UPON occupied 70% by weight. The lithium salt-containing polymer proportion was 30%.

A Cu foil, the anode layer, the separator layer, the cathode layer, and an Al foil were assembled and laminated together. The cell was then irradiated with electron beam at room temperature until a total dosage of 40 Gy was reached. In-situ polymerization of the polymerizable liquid solvent in the battery cell was accomplished. The same polymer was present throughout the anode layer, separator, and cathode layer, eliminating the high interfacial resistance problem commonly associated with the conventional inorganic solid electrolyte-based battery.

### Example 9: Composite Particulates Comprising Poly(Acrylonitrile) as a First Polymer and Cyanoethyl Poly(Vinyl Alcohol) (PVA-CN) as a Second Polymer

The second polymer, cyanoethyl poly(vinyl alcohol), was prepared by gelation of a precursor solution containing 2 wt. % PVA-CN dissolved in a liquid electrolyte that contained 1 M LiPF₆ in a mixture solution of ethylene carbonate (EC)/dimethyl carbonate (DMC)/ethylmethyl carbonate (EMC) with a volume ratio of 1:1:1. PAN-based composite particulates similar to those produced in Example 7 were then immersed in this polymer solution, allowing the PVA-CN solution to wet the composite particulate surfaces and also get slightly anchored on surface porosity.

In one sample, these composite droplets were then combined and consolidated into a cathode film. The precursor solution in the film was heated at a temperature of 70° C. to obtain PVA-CN encapsulated composite cathodes.

### Example 10: Production of from Vinylphosphonic Acid (VPA)- and Poly(Vinyl Carbonate)-Based Composite Particulates

Liquid vinylene carbonate (VC), in the presence of a lithium salt, can be polymerized into poly(vinyl carbonate) (PVCA) catalyzed by a thermally initialized radical initiator. The lithium salt, lithium difluoro(oxalate) borate (LiDFOB) has the combined chemical structures of lithium bis(oxalate) borate and lithium tetrafluoroborate (LiBF₄). In an experiment, 1.43 g LiDFOB was dissolved in to 10 mL VC to obtain a homogeneous and transparent solution (1.0 μm LiDFOB in VC, ≈9.6% (w/w)) and then the solution was added with 10 mg AIBN to form a reactive VC solution.

In a vessel provided with a reflux condenser, 150 parts vinylphosphonic acid were dissolved in 150 parts isopropanol and heated for 0.5 hours at 80° C. together with 0.75 parts benzoyl peroxide and 20 parts of lithium bis(oxalato)borate (LiBOB) to initiate the polymerization of vinylphosphonic acid in isopropanol. This polymerizing vinylphosphonic acid solution was then mixed with the reactive VC solution to form a reactive mixture solution.

Desired amounts of anode active particles (Si), Li₁₀GeP₂S₁₂ (LGPS)-type nano-particles, and carbon nanotubes were then combined with this reactive mixture solution using a pan-coating procedure to produce reactive composite micro-droplets. The droplets were formed into a film on a Cu foil and maintained at 60° C. for 2 h in a vacuum oven to advance the polymerization of vinylene carbonate and vinylphosphonic acid to an extent that the particulates were no longer flow like a liquid. Polyvinylphosphonic acid was added to improve the resistance to thermal runaway of the battery.

In a similar manner, a layer of consolidated NCM-622-based cathode was formed on an Al foil surface, all other ingredients remaining unchanged. A separator layer was prepared from 85% by weight of LGPS-type nano-particles and the same lithium salt-containing reactive vinylphosphonic acid solution. The anode, the separator and the cathode were laminated together and heated at 80° C. for 20 hours under a light pressure to form a battery cell.

### Examples 11: Crosslinked Polymer Electrolyte (LiBAMB-PETMP Single Ion-Conducting Polymer Electrolyte)-Poly(LiFPA)-Embedded Composite Particulates

The experiment began with the synthesis of lithium bis(allylmalonato)borate (LiBAMB). In a representative procedure, allylmalonic acid (60 mmol), lithium carbonate (15 mmol) and boric acid (30 mmol) were added in 150 mL dry acetonitrile to form a solution. The solution was heated under nitrogen gas flow in an oil bath at 80° C. for 12 h. After cooling down, the solution mass was filtered and the solvent was removed under reduced pressure. A white solid was obtained after drying in a vacuum oven at 60° C. for 48 h.

Subsequently, the LiBAMB-PETMP single lithium ion-conducting polymer electrolyte was synthesized from pentaerythritol tetrakis(2-mercaptoacetate) (PETMP) and LiBAMA. In an argon filled glove box, LiBAMB (2.5 mmol), PETMP (1.25 mmol) and 2,2-dimethoxy-2-phenylacetophenone (DMPA, 0.25 mmol) were dissolved in 5 mL gamma-butyrolactone (GBL) to form a reactive solution. A desired amount (83%) of Si nano particles (as an example of an anode active material), garnet-type solid electrolyte particles (5%), and some conducting fillers (5% of graphene sheets and carbon black), all based on the final composite particulate weight, were dispersed in the reactive solution to form a reactive slurry, which was quickly spray-dried to form reactive composite micro-droplets. The micro-droplets were then exposed to UV light (365 nm) at 80° C. for 1 hour to form composite particulates.

Separately, a precursor to a second single-ion polymer electrolyte (SIPE) was prepared from an aluminum (Al) based lithium salt (perfluoropinacolatoaluminate (LiFPA)) as monomer precursor (LiFPA itself being also an initiator). The reactive solution was prepared by dissolving LiFPA in a liquid mixture of ethyl methyl carbonate (EMC) and fluoroethylene carbonate (FEC) molecules to obtain 1 M LiFPA EMC/FEC. The previously made composite particulates were then immersed in this reactive solution, allowing the reactive solution to wet the surfaces of the composite particulates. A sample of these surface-wetted composite particulates was then compacted and consolidated together to form an anode film on a Cu foil. A cathode film was made in a similar manner with NCM-811 particles and a separator layer was also made that contains the same polymers and 80% garnet-type solid electrolyte particles, but no electrode active materials and no electron-conducting additive. The anode film, separator layer, and cathode film were then laminated and exposed to heat at 60° C. for 12 hours to complete the reactions, forming a substantially solid-state battery.

### Example 12: Preparation of Composite Particulates Based on In Situ Curing of Two Types of Cyclic Esters of Phosphoric Acid

As selected examples of polymers from phosphates, five-membered cyclic esters of phosphoric acid of the general formula: —CH₂CH(R)OP(O)—(OR′)O— were polymerized to solid, soluble polymers of high molecular weight by using n-C₄H₉Li, (C₅H₅)₂Mg, or (i-C₄H₉)₃Al as initiators. The resulting polymers have a repeating unit as follows:

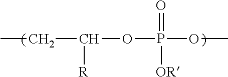

where R may be H, with R′═H, CH₃, C₂H₅, n-C₃H₇, i-C₃H₇; n-C₄H₉, CCl₃CH₂, or C₆H₅, or R is CH₂Cl and R′ is C₂H₅. The polymers typically have Mₙ=10⁴-10⁵. In the present study, as an example, R═H and R′═H, CH₃ and C₂H₅, respectively

In a representative procedure, initiators n-C₄H₉Li (0.5% by weight) and 5% lithium bis(oxalato)borate (LiBOB) as a lithium salt were mixed with 2-alkoxy-2-oxo-1,3,2-dioxaphospholan (R′═H and CH₃ in the following chemical formula) to form a reactive liquid containing two types of monomers:

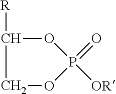

Nano particles of sulfide-type solid electrolyte, graphene sheets (as an electron-conducting additive), and NCA particles (lithium nickel cobalt aluminum oxide) were then added into the reactive liquid to form a reactive slurry. The reactive slurry was cast onto a glass surface preset at 0° C. to form composite particulates. The composite particulates were collected and placed in a mold cavity to form a composite layer under pressure. The anionic polymerization was allowed to proceed at room temperature (or lower) overnight to produce a cathode layer comprising a solid state polymer electrolyte.

1. Multi-functional composite particulates for a lithium battery, wherein at least one of said composite particulates has a diameter from 100 nm to 50 μm and comprises (a) a polymer electrolyte comprising a first polymer and a precursor to a second polymer, comprising from 0% to 50% by weight of a lithium salt dissolved or dispersed in said polymer electrolyte, wherein said second polymer precursor comprises a polymerizable, polymerizing, cross-linkable, and/or cross-linking liquid comprising a monomer, an oligomer, an initiator, and/or a cross-linking agent and said first polymer and said second polymer precursor form a mixture having a first polymer-to-second polymer weight ratio from 1/99 to 99/1; (b) a plurality of primary particles of an anode or cathode active material that are embedded in, dispersed in, encapsulated by, or bonded by said polymer electrolyte, which has a lithium ion conductivity from 10⁻⁸ to 5×10⁻² S/cm and wherein said active material primary particles have a diameter or thickness from 1 nm to 20 μm and occupy a weight fraction from 5% to 98% based on the total weight of the composite particulate; (c) particles of an inorganic material having a diameter or thickness from 2 nm to 20 μm and occupying a weight fraction from 0% to 30% based on the total weight of the composite particulate; and (d) an electron-conducting additive having a weight fraction of 0% to 30% based on the total weight of the composite particulate.

2. (canceled)

3. The multi-functional composite particulates of claim 1, wherein the second polymer precursor comprises a polymerizable liquid solvent selected from the group consisting of organic compounds containing unsaturated C═C bonds, cyclic carbonates, cyclic esters, cyclic ethers, and combination thereof.

4. The multi-functional composite particulates of claim 1, wherein the second polymer precursor comprises a polymerizable liquid solvent selected from acrylate, allyl, and vinyl ether monomers or oligomers, vinyl ethylene carbonate (VEC), vinylene carbonate (VC), acrylate or methyl acrylate (such as methyl methacrylate and butyl acrylate), fluorinated vinyl carbonates, vinyl containing phosphates, phosphonate or phosphonic acid (e.g., diethyl allylphosphonate diethyl vinylphosphonate, dimethyl vinylphosphonate, etc.), vinyl acetate, unsaturated phosphazene, vinyl containing ionic liquid (such as 1-vinyl-3-dodecylimidazolium bis(trifluoromethanesulfonyl)imide), functional vinyl sulfide, sulfoxide, or sulfone, Alkyl(meth)acrylate, N,N-dialkylacrylamide, vinyl alkyl ketone, meth(acrylo)nitrile, ethylene oxide, propylene sulfide, alpha-cyanoacrylate, vinylidene cyanide, ε-caprolactone, and ε-caprolactam, vinyl ether and its derivatives, α-methyl vinyl ether, 1,3-dioxolane (DOL), tetrahydrofuran (THF), trioxymethylene, oxazoline, oxetan-2-one, oxirane and thietane, ethylene carbonate (EC), VC, VEC, propylene carbonate (PC), trimethylene carbonate (TMC), organic compounds with epoxy group, —NH₂ group or SH group, or a combination thereof.

5. (canceled)

6. The multi-functional composite particulates of claim 1, wherein the second polymer precursor comprises a polymerizable liquid solvent selected from acrylate, allyl, and vinyl ether monomers or oligomers, vinyl ethylene carbonate (VEC), vinylene carbonate (VC), acrylate or methyl acrylate (such as methyl methacrylate and butyl acrylate), fluorinated vinyl carbonates, vinyl containing phosphates, phosphonate or phosphonic acid (e.g., diethyl allylphosphonate diethyl vinylphosphonate, dimethyl vinylphosphonate, etc.), vinyl acetate, unsaturated phosphazene, vinyl containing ionic liquid (such as 1-vinyl-3-dodecylimidazolium bis(trifluoromethanesulfonyl)imide), functional vinyl sulfide, sulfoxide, or sulfone, Alkyl(meth)acrylate, N,N-dialkylacrylamide, vinyl alkyl ketone, meth(acrylo)nitrile, ethylene oxide, propylene sulfide, alpha-cyanoacrylate, vinylidene cyanide, ε-caprolactone, and ε-caprolactam, vinyl ether and its derivatives, α-methyl vinyl ether, 1,3-dioxolane (DOL), tetrahydrofuran (THF), trioxymethylene, oxazoline, oxetan-2-one, oxirane and thietane, ethylene carbonate (EC), VC, VEC, propylene carbonate (PC), trimethylene carbonate (TMC), organic compounds with epoxy group, —NH₂ group or SH group, or a combination thereof.

7. The multi-functional composite particulates of claim 1, wherein the second polymer precursor comprises chemical species selected from the group consisting of fluorinated monomers having unsaturation for polymerization, sulfones, sulfides, nitriles, phosphates, phosphites, phosphonates, phosphazenes, sulfates, siloxanes, silanes, 1,3-dioxolane (DOL), tetraethylene glycol dimethylether (TEGDME), poly(ethylene glycol)dimethyl ether (PEGDME), diethylene glycol dibutyl ether (DEGDBE), 2-ethoxyethyl ether (EEE), fluoroethylene carbonate (FEC), vinylene carbonate (VC), allyl ethyl carbonate (AEC), tetrahydrofuran (THF), and combinations thereof.

8. The multi-functional composite particulates of claim 1, wherein said first polymer is selected from a thermoplastic, a thermoset or cross-linked polymer, a rubber or elastomer, a semi-interpenetrating network, a simultaneous interpenetrating network, or a combination thereof.

9. The multi-functional composite particulates of claim 1, wherein said first polymer is selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer (e.g., those with a carboxylate anion, a sulfonylimide anion, or sulfonate anion), poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), an acrylic polymer, a copolymer thereof, a semi-penetrating network thereof, a sulfonated derivative thereof, or a combination thereof.

10. (canceled)

11. The multi-functional composite particulates of claim 1, wherein said first polymer comprises an elastomer or rubber selected from natural polyisoprene, synthetic polyisoprene, polybutadiene, chloroprene rubber, polychloroprene, butyl rubber, butyl acrylic rubber, styrene-butadiene rubber, nitrile rubber, ethylene propylene rubber, ethylene propylene diene rubber, epichlorohydrin rubber, polyacrylic rubber, silicone rubber, polysiloxane, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polyurethane, urethane-urea copolymer, a copolymer thereof, a chemically substituted version thereof, a chemical derivative thereof, a sulfonated version thereof, or a combination thereof.

12. The multi-functional composite particulates of claim 7, wherein the fluorinated monomer is selected from the group consisting of fluorinated vinyl carbonates, fluorinated vinyl monomers, fluorinated esters, fluorinated vinyl esters, and fluorinated vinyl ethers and combinations thereof.

13. The multi-functional composite particulates of claim 7, wherein the sulfone or sulfide is selected from vinyl sulfone, allyl sulfone, alkyl vinyl sulfone, aryl vinyl sulfone, vinyl sulfide, a vinyl-containing variant of TrMS, MTrMS, TMS, EMS, MMES, EMES, EMEES, or a combination thereof:

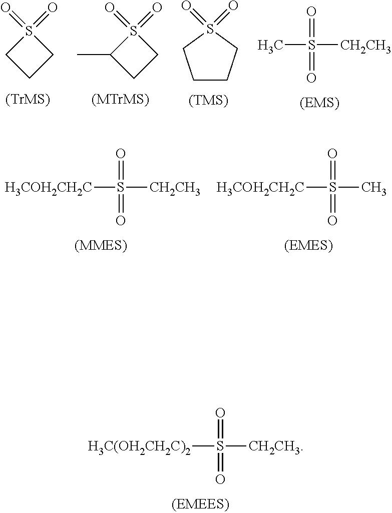

14. The multi-functional composite particulates of claim 13, wherein the vinyl sulfone or sulfide is selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof, wherein the vinyl sulfone does not include methyl ethylene sulfone and ethyl vinyl sulfone.

15. The multi-functional composite particulates of claim 7, wherein the nitrile comprises a dinitrile or is selected from AND, GLN, SEN, and succinonitrile (SN), or a combination thereof:

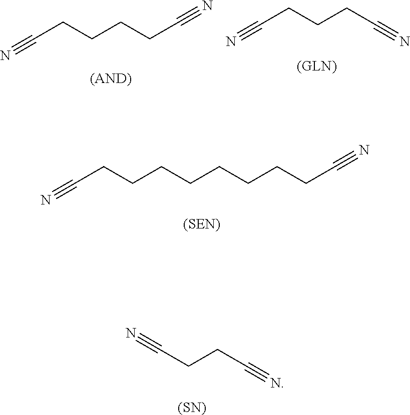

16. The multi-functional composite particulates of claim 7, wherein the phosphate is selected from allyl-type, vinyl-type, styrenic-type and (meth)acrylic-type monomers bearing a phosphonate moiety.

17. The multi-functional composite particulates of claim 7, wherein the phosphate, phosphonate, phosphonic acid, phosphazene, or phosphite is selected from TMP, TEP, TFP, TDP, DPOF, DMMP, DMMEMP, tris(trimethylsilyl)phosphite (TTSPi), alkyl phosphate, triallyl phosphate (TAP), a combination thereof, wherein TMP, TEP, TFP, TDP, DPOF, DMMP, DMMEMP, and phosphazene have the following chemical formulae: 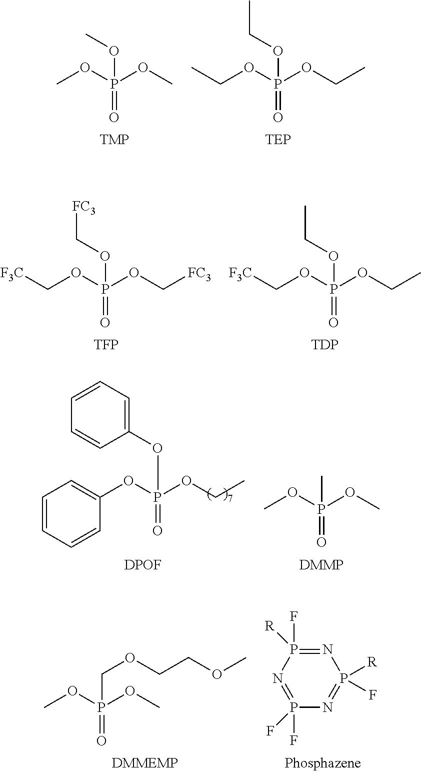
wherein R═H, NH₂, or C₁-C₆ alkyl.

18. The multi-functional composite particulates of claim 7, wherein the siloxane or silane is selected from alkylsiloxane (Si—O), alkylsilane (Si—C), liquid oligomeric siloxane (—Si—O—Si—), or a combination thereof.

19. The multi-functional composite particulates of claim 1, wherein the second polymer precursor comprises an amide group selected from N,N-dimethylacetamide, N,N-diethylacetamide, N,N-dimethylformamide, N,N-diethylformamide, or a combination thereof.

20. The multi-functional composite particulates of claim 1, wherein the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule.

21. The multi-functional composite particulates of claim 1, wherein the crosslinking agent is selected from poly(diethanol)diacrylate, poly(ethyleneglycol)dimethacrylate, poly(diethanol)dimethylacrylate, poly(ethylene glycol) diacrylate, or a combination thereof.

22. The multi-functional composite particulates of claim 1, wherein said initiator is selected from an azo compound, azobisisobutyronitrile, azobisisoheptonitrile, dimethyl azobisisobutyrate, benzoyl peroxide ter-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecanoyl peroxide, isobutyryl peroxide, cumene hydroperoxide, tert-butyl peroxypivalate, diisopropyl peroxydicarbonate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

23. The multi-functional composite particulates of claim 1, wherein said lithium salt is selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium trifluoromethanesulfonimide, LiTFSI, an ionic liquid-based lithium salt, or a combination thereof.

24. The multi-functional composite particulates of claim 1, wherein said composite particulate is further encapsulated by a shell of conducting material selected from graphene, carbon, graphite, metal, conductive composite, or a combination thereof, wherein said shell has an electrical conductivity from 10⁻⁸ S/cm to 10³ S/cm and a thickness from 0.34 nm to 10 μm.

25. The multi-functional composite particulates of claim 1, wherein said conductive additive is selected from carbon nanotubes, carbon nano-fibers, carbon or graphite fibers, graphene sheets, expanded graphite flakes, metal filaments or metal nano-wires, whiskers, carbon black, acetylene black, needle coke, carbon particles, graphite particles, a combination thereof, or a combination thereof, wherein said graphene sheets are selected from pristine graphene, graphene fluoride, graphene chloride, graphene bromide, graphene iodide, nitrogenated graphene, hydrogenated graphene, doped graphene, chemically functionalized graphene, a combination thereof, or a combination thereof with graphene oxide or reduced graphene oxide.

26. The multi-functional composite particulates of claim 1, wherein said anode active material is selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide; (f) prelithiated versions thereof; (g) particles or a film of Li, Li alloy, or surface-stabilized Li having at least 60% by weight of lithium element therein; (h) graphite and carbon particles; and (i) combinations thereof.

27. The multi-functional composite particulates of claim 26, wherein said Li alloy contains from 0.1% to 10% by weight of a metal element selected from Zn, Ag, Au, Mg, Ni, Ti, Fe, Co, V, Al, or a combination.

28. The multi-functional composite particulates of claim 1, wherein said anode active material contains a prelithiated Si, prelithiated Ge, prelithiated Sn, prelithiated SnOₓ, prelithiated SiOₓ, prelithiated iron oxide, prelithiated Mn₃O₄, prelithiated Co₃O₄, prelithiated Ni₃O₄, lithium titanate, lithium niobite, or a combination thereof, wherein x=1 to 2.

29. The multi-functional composite particulates of claim 1, wherein said cathode active material is selected from an inorganic material, an organic material, a polymeric material, or a combination thereof.

30. The multi-functional composite particulates of claim 29, wherein said inorganic material, as a cathode active material, is selected from sulfur, selenium, a metal oxide, metal phosphate, metal silicide, metal selenide, metal sulfide, or a combination thereof.

31. The multi-functional composite particulates of claim 29, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

32. The multi-functional composite particulates of claim 29, wherein said inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

33. The multi-functional composite particulates of claim 30, wherein said metal oxide or metal phosphate is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

34. The multi-functional composite particulates of claim 29, wherein the cathode active material comprises lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

35. The multi-functional composite particulates of claim 1, wherein said primary particles of anode or cathode active material are in a form of nano particle, nano wire, nano fiber, nano tube, nano sheet, nano belt, nano ribbon, nano disc, nano platelet, or nano horn having a thickness or diameter from 0.5 nm to 100 nm.

36. The multi-functional composite particulates of claim 1, wherein at least one of said primary anode or cathode active material particles is coated with a layer of carbon, graphite, or graphene.

37. The multi-functional composite particulates of claim 1, wherein said particles of inorganic material comprises particles of an inorganic solid electrolyte material selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

38. The multi-functional composite particulates of claim 1, wherein said particles of inorganic material is selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

39. A powder mass comprising the multi-functional composite particulates of claim 1,
wherein the particulates comprise primary particles of an anode active material.

40. A powder mass comprising the multi-functional composite particulates of claim 1,
wherein the particulates comprise primary particles of a cathode active material.

41. (canceled)

42. A battery anode or negative electrode that comprises the multi-functional composite particulates of claim 1 as an anode material or is made from the multi-functional composite particulates.

43. A battery cathode or positive electrode that comprises the multi-functional composite particulates of claim 1 as a cathode material or is made from the multi-functional composite particulates.

44. A battery comprising the multi-functional composite particulates of claim 1 as an anode material or a cathode material, wherein the battery is a lithium-ion battery, lithium metal battery, lithium-sulfur battery, lithium-air battery, or lithium-selenium battery.

45.-60. (canceled)
